(19) United States
(12) Patent Application Publication
(10) Pub. No.: US 2026/0278440 A1
(43) Pub. Date: Sep. 17, 2026

(54) DUAL-HELIX QUANTUM ARCHITECTURE FOR ACCELERATED QUANTUM WORKLOAD EXECUTION

(71) Applicant: Homatch.ai, Milpitas, CA (US)

(72) Inventor: Mingjun Wang, Saratoga, CA (US)

(21) Appl. No.: 19/455,637

(22) Filed: Jan. 21, 2026

Related U.S. Application Data
(60) Provisional application No. 63/748,910, filed on Jan. 23, 2025.
(60) Provisional application No. 63/749,253, filed on Jan. 24, 2025.
(60) Provisional application No. 63/753,176, filed on Feb. 3, 2025.
(60) Provisional application No. 63/753,181, filed on Feb. 3, 2025.

(51) Int. Cl. G06N 10/40; G06N 10/20

(52) U.S. Cl. CPC G06N 10/40; G06N 10/20

(57) ABSTRACT

A computer-implemented method for executing an artificial intelligence task on a quantum computing architecture may include obtaining computational elements associated with the artificial intelligence task. The method may also include determining similarity relationships among the computational elements based on at least one of statistical similarity, interaction frequency, connectivity strength, spatial adjacency within a data representation, or graph-based correlation metrics. The method may further include providing a quantum computing architecture comprising quantum nodes arranged along two intertwined helices, each quantum node being associated with an angular position along a helical path and assigning the computational elements to the quantum nodes based on the similarity relationships such that computational elements having higher similarity are assigned to quantum nodes having smaller angular separation along at least one of the intertwined helices. The method may further include executing quantum gate operations associated with the artificial intelligence task between quantum nodes.

### RELATED APPLICATIONS

This application claims the benefit of and priority to U.S. Provisional Application No. 63/749,253 filed on Jan. 24, 2025, U.S. Provisional Application No. 63/753,176 filed on Feb. 3, 2025, U.S. Provisional Application No. 63/753,181 filed on Feb. 3, 2025, and U.S. Provisional Application No. 63/748,910 filed on Jan. 23, 2025, the entire contents of which are hereby incorporated by reference in their entireties.

### TECHNICAL FIELD

The present disclosure relates to a dual-helix quantum architecture for accelerated quantum workload execution.

### BACKGROUND

Unless otherwise indicated herein, the materials described herein are not prior art to the claims in the present application and are not admitted to be prior art by inclusion in this section.

Quantum computing systems utilize quantum mechanical phenomena such as superposition and entanglement to perform computations that may be infeasible for classical computing systems. As quantum hardware scales, architectural organization, routing efficiency, and execution coordination become increasingly significant challenges.

Artificial intelligence workloads, including neural network training, optimization, and inference, impose additional demands on quantum computing systems. Such workloads often require repeated parameter updates, structured data flow, parallel execution, and coordination between quantum and classical processing components. Conventional planar quantum architectures may encounter limitations in scalability, routing complexity, and execution efficiency when applied to these workloads.

Accordingly, there is an ongoing need for quantum computing architectures and execution frameworks that improve spatial organization, support parallel execution, and provide flexibility for a wide range of quantum algorithms and artificial intelligence workloads.

The subject matter claimed herein is not limited to embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In some embodiments, a computer-implemented method for executing an artificial intelligence task on a quantum computing architecture may include obtaining a plurality of computational elements associated with the artificial intelligence task. The method may also include determining similarity relationships among the computational elements based on at least one of statistical similarity, interaction frequency, connectivity strength, spatial adjacency within a data representation, or graph-based correlation metrics. The method may further include providing a quantum computing architecture comprising a plurality of quantum nodes arranged along two intertwined helices, each quantum node being associated with an angular position along a helical path and assigning the computational elements to the quantum nodes based on the similarity relationships such that computational elements having higher similarity are assigned to quantum nodes having smaller angular separation along at least one of the intertwined helices. The method may further include executing quantum gate operations associated with the artificial intelligence task between quantum nodes that are adjacent along a helix or connected by cross-strand couplers.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION

The present application can be best understood by reference to the embodiments described below taken in conjunction with the accompanying drawing figures, in which like parts may be referred to by like numerals.

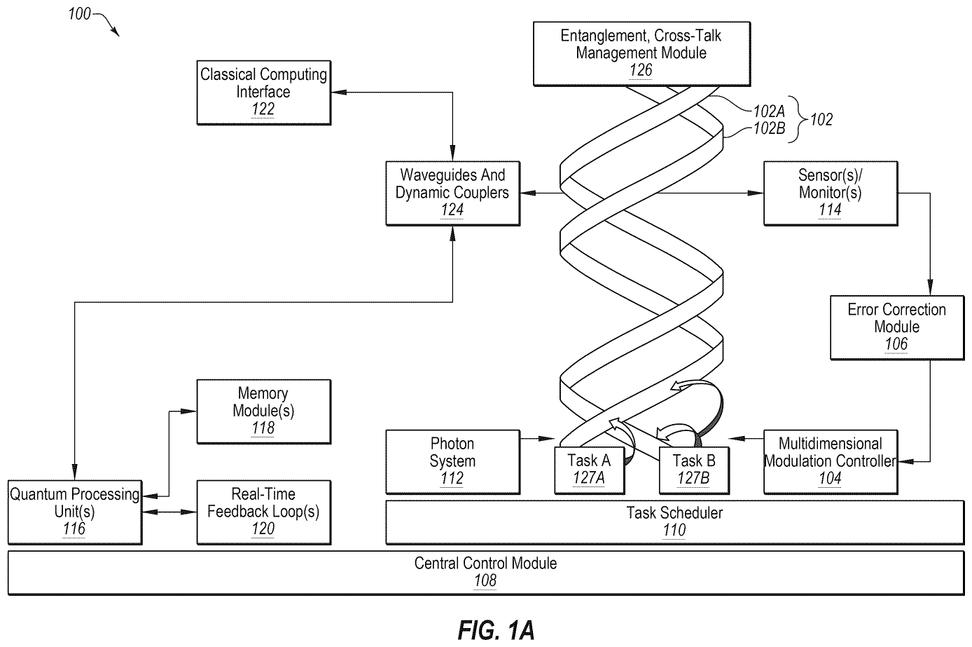

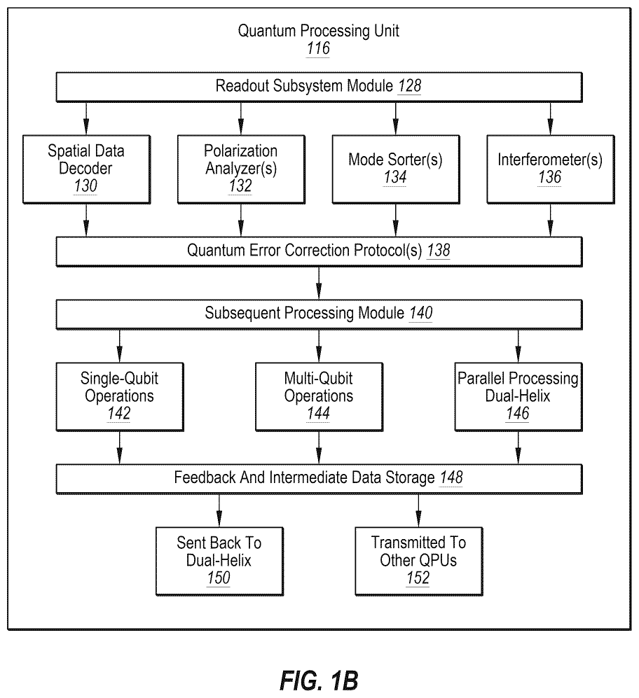

FIG. 1A illustrates an example quantum computing system that includes a dual-helix quantum architecture.

FIG. 1B illustrates an example implementation of a quantum processing unit (QPU) included in the quantum computing system of FIG. 1A.

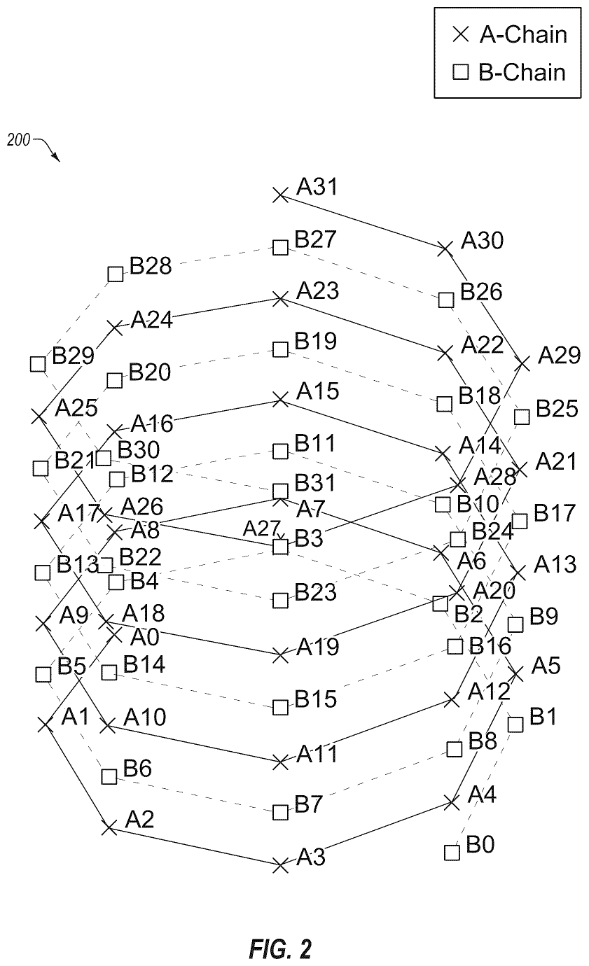

FIG. 2 is a view of an example dual-helix quantum architecture showing interleaved A-helix chain and B-helix chain quantum nodes.

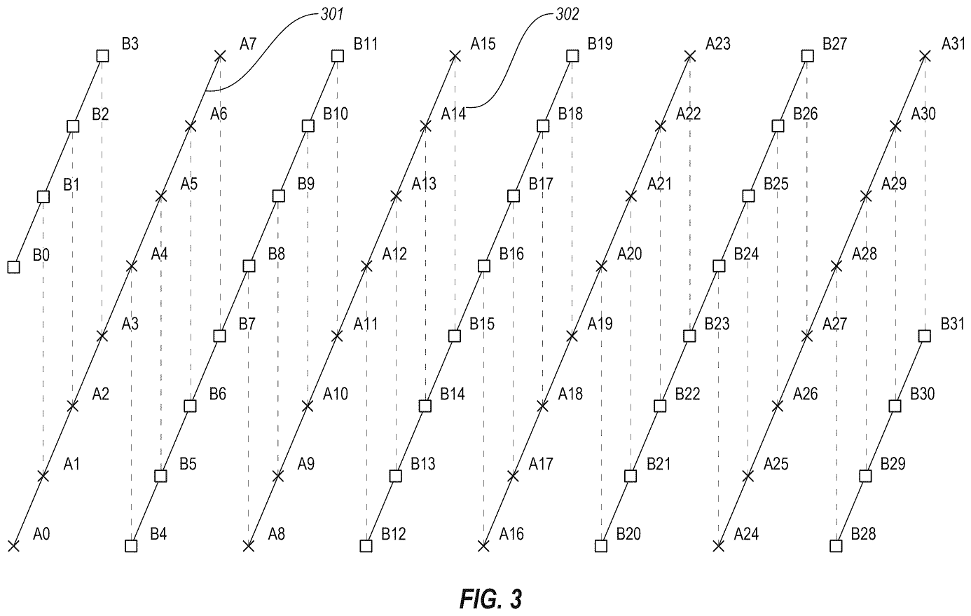

FIG. 3 is view illustrating an example spiral-unwrapped placement of quantum nodes on the A-helix chain and B-helix chain and quantum links between the quantum nodes.

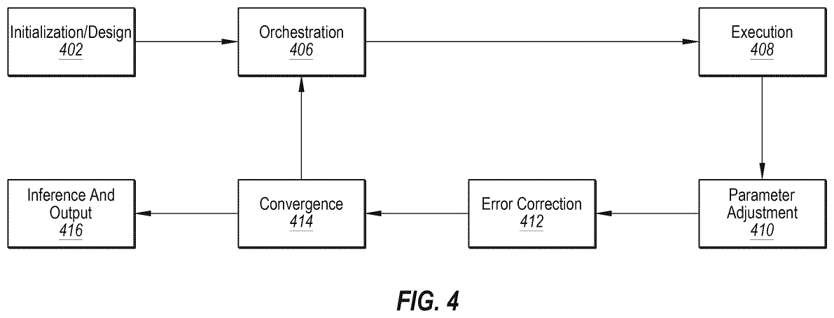

FIG. 4 illustrates an example process flow for quantum computing using a dual-helix quantum architecture.

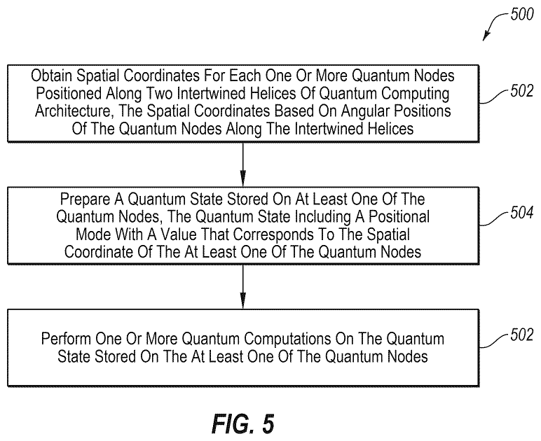

FIG. 5 depicts a flowchart of an example method of quantum computing.

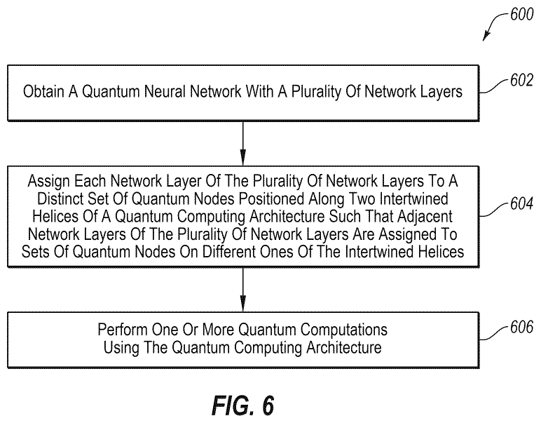

FIG. 6 depicts a flowchart of another example method of quantum computing.

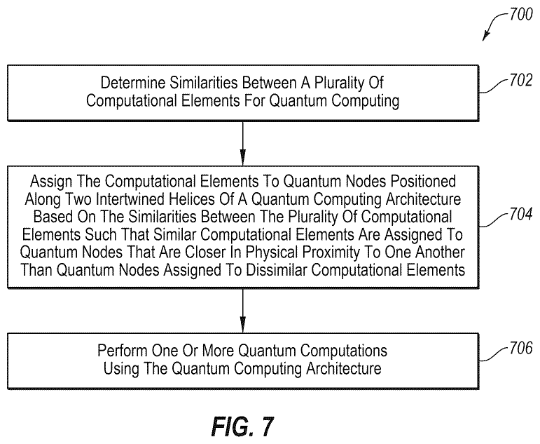

FIG. 7 depicts a flowchart of another example method of quantum computing.

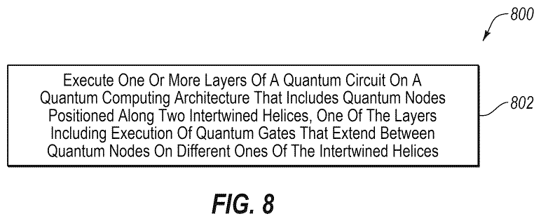

FIG. 8 depicts a flowchart of another example method of quantum computing.

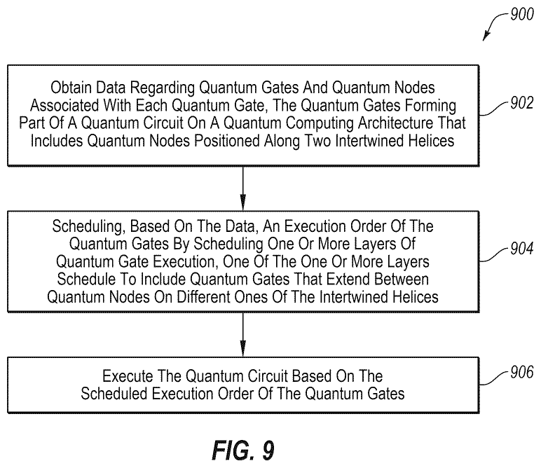

FIG. 9 depicts a flowchart of another example method of quantum computing.

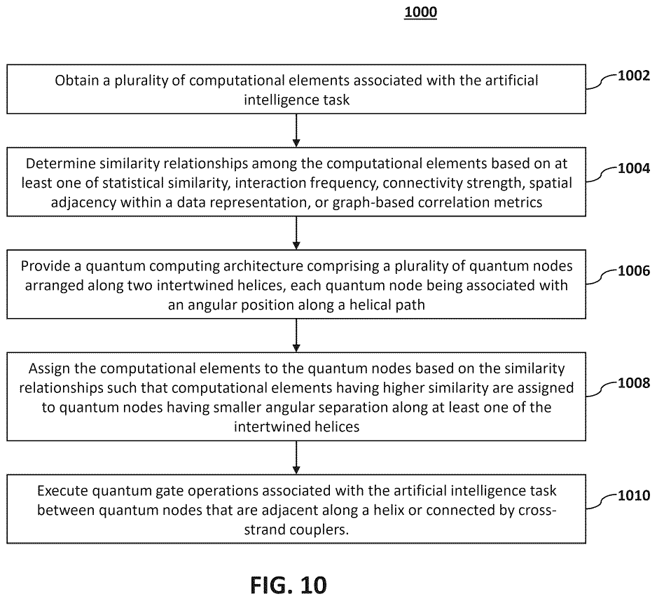

FIG. 10 depicts a flowchart of another example method of quantum computing.

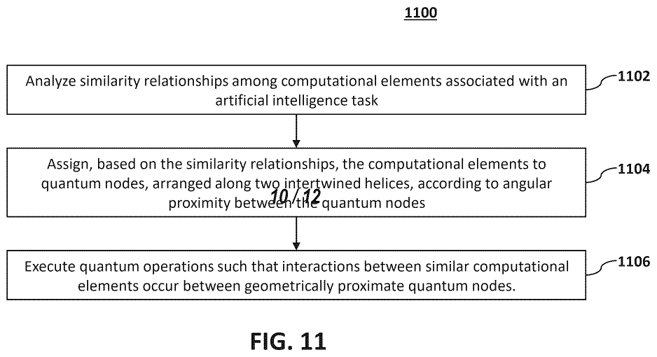

FIG. 11 depicts a flowchart of another example method of quantum computing.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

The field of quantum computing has seen significant advancements in recent years. However, challenges remain in practical scaling, including routing overhead, interaction locality mismatch between logical workloads and physical topology, and fidelity loss associated with repeated long-range operations.

Many workloads, including AI workloads, involve heterogeneous interaction patterns among computational elements. Conventional placement approaches may map elements without regard to interaction affinity, leading to excessive long-range coupling, increased hop count for state transfer, and increased circuit depth. These effects can reduce fidelity and increase runtime.

Some embodiments disclosed herein address these challenges using a similarity-aware placement mechanism on a dual-helix architecture. The dual-helix architecture provides a structured geometry in which (i) angular coordinate defines a natural ordering along each helix and (ii) cross-strand rung couplers provide low-hop connectivity between corresponding angular positions. The placement mechanism assigns interacting computational elements to nodes that are close in angular separation and/or connected by rung couplers.

In some embodiments, each quantum node is associated with a spatial coordinate derived from its angular position along the helix. The spatial coordinate may be used as an address and as a constraint for placement. A placement controller may compute an assignment map from computational element identifiers to node identifiers such that elements expected to interact frequently are placed within a local neighborhood of the dual-helix topology.

In some embodiments, the placement controller restricts or prioritizes interactions among nodes within local neighborhoods to reduce communication overhead. Local neighborhoods may be defined by angular proximity along a helix, by cross-strand pairing through rung couplers, or by a bounded hop distance in a connectivity graph. Such restrictions or priorities reduce the need for long-range routing operations and reduce circuit depth for interactions among high-similarity elements.

In some embodiments, similarity-aware placement is generated using similarity metrics derived from data values, embedding distance, correlation estimates, and/or connectivity scores derived from an interaction graph. The mapping may be computed by sorting elements by similarity, clustering elements into groups, partitioning an interaction graph, or minimizing a placement objective that incorporates similarity-weighted distance on the dual-helix topology. The placement objective may include terms for angular distance, cross-strand coupling availability, congestion, and/or link fidelity.

In some embodiments, similarity-aware placement reduces inter-node communication by co-locating similar computational elements and thereby reducing state transfer operations, reducing the number of non-local entangling operations, and reducing the number of hops required to implement interaction terms. The placement may be applied to a wide range of computational element types including data elements, variables, tokens, and intermediate representations without requiring a specific learning model or training algorithm.

### Overview of Dual-Helix Quantum Architecture

In general, a quantum computing architecture as used in the embodiments described herein may include a plurality of quantum nodes arranged along two intertwined helices. The intertwined helices may extend along a longitudinal axis and may be offset angularly from one another. Each helix may include multiple quantum nodes positioned at different angular locations along the helix. An example dual-helix architecture is provided with respect to FIG. 2.

The dual-helix architecture provides a spatial organization in which quantum nodes have well-defined adjacency relationships along a helix and between helices. Quantum nodes on one helix may be coupled to corresponding or nearby nodes on the other helix using inter-helix connections, which may be referred to as rungs. These rungs may enable quantum communication, entanglement, or state transfer between the helices.

The dual-helix architecture and associated system are described with respect to FIGS. 1A, 1B, 2, and 3. This dual-helix architecture is one example of a spatially organized quantum computing system. Other spatial arrangements may also be used, and the disclosed techniques are not limited to any particular physical geometry unless expressly stated in the claims.

FIG. 1A illustrates an example quantum computing system 100 (hereinafter “system 100”) that includes such a dual-helix quantum encoding architecture, arranged in accordance with at least one embodiment herein. In particular, the system 100 includes a dual-helix quantum encoding structure 102 (hereinafter “dual-helix structure 102”), a multidimensional modulation controller 104 (hereinafter “controller 104”), and an error correction module 106. The system 100 may further include a central control module 108, a task scheduler 110, a photon system 112, one or more sensors 114 (hereinafter generically “sensors 114” or “sensor 114”), one or more quantum processing units (QPUs) 116, one or more memory modules 118, one or more real-time feedback loops 120, a classical computing interface 122, one or more waveguides and/or dynamic couplers 124, and an entanglement and cross-talk management module 126 (hereinafter “entanglement module 126”).

In general, the dual-helix structure 102 may include a first helix chain 102A and a second helix chain 102B. Each of the first helix chain 102A and the second helix chain 102B may include at least one of high-transparency quartz, fused silica, silicon nitride (SiN), lithium niobate (LiNbO₃), or other suitable material(s). The controller 104 may be configured to modulate quantum information in the first and second helix chains 102A, 102B using one or more of frequency modulation, phase modulation, and amplitude modulation. The dual-helix structure 102 may be configured to perform parallel quantum operations within the first helix chain 102A and the second helix chain 102B, e.g., under the direction or control of one or more of the central control module 108 or the task scheduler 110. The error correction module 106 may be configured to implement error correction within the first and second helix chains 102A, 102B using frequency modulation, phase modulation, and amplitude modulation provided through the controller 104.

The helix chains 102A, 102B may operate in parallel, each processing different quantum tasks simultaneously. The architecture of the system 100 may dynamically assign tasks to different helix chains 102A, 102B based on the complexity of the computations.

The system 100 may monitor, e.g., constantly or continuously, the modulated dimensions of frequency, phase, and amplitude of the helix chains 102A, 102B. For example, the sensors 114 may monitor the modulated dimensions of each of the first and second helix chains 102A, 102B. If one modulated dimension experiences an error (e.g., a phase drift), the system 100 may detect the error through real-time monitoring, e.g., by the sensors 114, and correct the error using the unaffected dimensions, e.g., using the error correction module 106, to restore an intended quantum state and/or maintain quantum state coherence.

The controller 104 may modulate the frequency, phase, and/or amplitude of each helix chain 102A, 102B in real-time. The controller 104 may ensure that each helix chain 102A, 102B operates at an optimal modulation level to prevent overlap or signal degradation. For example, the controller 104 may be configured to modulate, respectively, the phase, the frequency, and the amplitude of the dual-helix structure 102 of FIG. 1A. The controller 104 modulating the phase, frequency, and/or amplitude of the dual-helix structure 102 may include the controller 104 modulating the properties of individual photons that are processed at the various nodes of the dual-helix structure 102, rather than modifying structural properties of the dual-helix structure 102 itself.

Alternatively or additionally, a phase coupling mechanism may be implemented using the controller 104, together with one or more sensors 114, and/or the error correction module 106. The phase coupling mechanism may ensure phase synchronization between the helix chains 102A, 102B to reduce computational errors caused by phase misalignment. The phase coupling mechanism may detect phase drifts (e.g., using a phase sensor of the sensors 114) and correct misalignment by adjusting the phase of the affected helix chain 102A, 102B via the error correction module 106 and/or the controller 104.

In an example implementation, the classical computing interface 122 of FIG. 1A may be configured to receive classical data input. The classical computing interface 122 may be configured to convert the classical data input into quantum information suitable for processing by the dual-helix structure 102 and/or any of the QPUs 116. The classical computing interface 122 may be configured to transmit the quantum information to the controller 104 for modulation and processing in the first and second helix chains 102A, 102B.

The dual-helix quantum encoding architecture embodied in the system 100 of FIG. 1 may serve as a foundation for transmitting, receiving, and decoding quantum-encoded photons. The system 100 may support encoding and transmission functionalities as well as quantum processing and memory/storage integration.

The system 100 may include or support quantum gates and circuits for performing operations on qubits stored within the helix chains 102A, 102B, examples of which are described with respect to FIG. 1B and which may be incorporated into the dual-helix structure 102. Processing may occur at designated quantum nodes along each helix chain 102A, 102B, where modulation of frequency, phase, and amplitude, e.g., using the controller 104, may enable operations such as quantum logic gates (e.g., CNOT, Hadamard).

The parallel nature of the helix chains 102A, 102B may allow for concurrent quantum computations. The task scheduler 110 may dynamically assign tasks across the helix chains 102A, 102B to optimize, or at least improve, computational throughput. Nodes within the dual-helix structure 102 may act as quantum memory units, storing quantum states encoded via frequency, phase, and amplitude modulation. Alternately or additionally, the nodes within the dual-helix structure 102 may act as quantum processing elements that store and manipulate quantum states for computational operations in quantum computing applications.

The dual-helix quantum encoding architecture depicted in FIG. 1A may be combined with conventional computing systems to create a hybrid quantum-classical system. For example, the classical computing interface 122 may receive classical data inputs and convert them into quantum-encoded information for processing and transmit quantum computation results back as classical data outputs.

FIG. 1B illustrates an example implementation of the QPU 116 of FIG. 1A, arranged in accordance with at least one embodiment herein. As illustrated, the QPU 116 of FIG. 1B may include one or more of a readout subsystem module 128 (hereinafter “readout module 128”), a spatial data decoder 130, one or more polarization analyzers 132, one or more mode sorters 134, one or more interferometers 136, one or more quantum error correction protocols 138, a subsequent processing module 140, one or more single-qubit operations 142, one or more multi-qubit operations 144, a parallel processing dual-helix 146, and a feedback and intermediate data storage 148. The single-qubit operations 142 may include, for example, a Hadamard gate or other suitable single-qubit operations. The multi-qubit operations 144 may include, for example, a controlled NOT gate (C-NOT), a Toffoli gate (or controlled-CNOT or CCNOT gate or SAWP gate), or other suitable multi-qubit operations. The parallel processing dual-helix 146 may be a subset or functional implementation of the dual helix structure 102 in FIG. 1A. The parallel processing dual-helix 146 may be optimized for use within a single QPU 116 (whereas the dual helix structure 102 may operate at the system level). The dual helix structure 102 may be a core component of the overall system 100 and may be integrated into one or more QPUs (116). However, the dual helix structure 102 may have broader functionality beyond a single QPU, supporting multiple QPUs and system wide parallel operations. Individual QPUs (116) may contain or include a localized implementation of a dual helix structure, referred to as the parallel processing dual-helix 146 herein. The feedback and intermediate data storage 148 may output data that may be, e.g., sent back to the dual-helix structure 102 of FIG. 1A at block 150 and/or transmitted to one or more other QPUs at block 152.

The waveguides and dynamic couplers 124 are depicted in FIG. 1A as being external to the dual-helix structure 102. In other embodiments, one or more of the waveguides and/or dynamic couplers 124 may be integrated directly into and/or embedded within the dual-helix structure 102, facilitating internal routing of encoded photons between processing nodes.

Referring to FIGS. 1A-1B, each QPU 116 includes a subsystem, such as the readout subsystem module 128, to detect and decode photons. The readout subsystem module 128 may include the spatial data decoder 130, the polarization analyzer 132, the mode sorter 134, and/or the interferometer 136. The readout subsystem module 128 may detect the incoming photons (received from the dual helix structure 102 via the waveguides and dynamic couplers 124) and extract quantum states using, e.g., the polarization analyzer 132 to detect polarization of each photon, the mode sorter 134 to detect OAM of each photon, and/or the interferometer 136 to detect the phase of each photon. The extracted quantum states may be mapped to qubits in the QPU 116 for subsequent processing.

The quantum error correction protocols 138 may be applied to ensure data integrity during transmission and decoding. The quantum error correction protocols 138 may include surface codes, Shor codes, or other suitable quantum error detection and/or correction protocols. The quantum error correction protocols 138 may be part of and/or implemented by the error correction module 106 of FIG. 1A. The quantum error correction protocols 138 may be an internal component or implementation of the broader error correction module 106. The QPU 116 may execute the quantum error correction protocols 138 as part of its quantum processing.

The subsequent processing module 140 may include the single-qubit operations 142, the multi-qubit operations 144, and/or the parallel processing dual-helix 146. The QPU 116 may perform single-qubit operations 142 (e.g., X, Z, Hadamard gates) to manipulate individual qubits based on a given computation task. The QPU 116 may also execute multi-qubit operations 144.

Processed quantum states generated by the subsequent processing module via the single-qubit operations 142, the multi-qubit operations 144, and/or the parallel processing dual-helix 146 may be sent back to the dual-helix structure 102 of FIG. 1A for storage or further routing, as indicated at block 150, and/or transmitted to other QPUs 116 for additional computation, as indicated at block 152. Quantum memory modules, such as the memory module 118 of FIG. 1A, may store intermediate results or checkpointed states for multi-step computations.

Referring to FIG. 1A, the central control module 108 may coordinate data flow between the dual-helix structure 102 and the QPUs 116, and may ensure that operations are synchronized. The central control module 108 may dynamically allocate QPU resources based on task priority and node availability. The real-time feedback loops 120 may monitor photon fidelity, gate execution, and/or routing efficiency. Adjustments may be made dynamically, e.g., as part of the real-time feedback loops 120, to minimize losses and optimize performance.

Further description of the system 100 is found in U.S. patent application Ser. No. 19/083,366, filed on Mar. 18, 2025, entitled Dual-Helix Quantum Encoding Architecture And Multidimensional Quantum Computing System and U.S. patent application Ser. No. 19/208,461, filed on May 14, 2025, entitled Quantum Secure Communication Protocol And Device Based On Double-Helix Structure Composite Multi-Layer Encoding, the entire disclosures of which are incorporated herein by reference in their entireties.

FIG. 2 is a view of an example dual-helix quantum architecture showing interleaved A-helix chain and B-helix chain quantum nodes, arranged in accordance with at least one embodiment herein. The layout includes A-helix chain quantum nodes, labeled A0 through A31 and denoted by crosses (A0-A31), and B-helix chain quantum nodes, labeled B0 through B31 and denoted by open squares (B0-B31), each arranged along two interleaved helical paths. The A-helix chain and B-helix chain helices are offset by approximately 180 degrees at each Z level, resulting in paired A and B quantum nodes at the same vertical (Z) position in 3D space. This arrangement visually represents the logical adjacency and pairing of A and B quantum nodes at each height, as well as the nearest-neighbor connections along each helix, as shown by the spatial relationships among the labeled quantum nodes in FIG. 2e.

In some embodiments, A-helix nodes and B-helix nodes are paired at substantially the same vertical position and/or with a defined angular offset, enabling cross-strand coupling (e.g., rung couplers) between paired indices. This arrangement provides a structured node topology in which angular proximity and cross-strand pairing can be exploited to place computational elements that have higher similarity at reduced hop distance.

The phrase “dual-helix logical node layout,” as used in this disclosure, refers to an arrangement of quantum nodes in 3D space in which two interleaved chains of quantum nodes follow helical paths, with each chain offset from the other by a fixed angular phase. The purpose of the dual-helix logical quantum node layout is to provide a logical framework for organizing quantum nodes such that both local and cross-chain adjacency are preserved, thereby supporting efficient routing and scalable quantum processor architectures. The term “logical” is used herein to clarify that the node organization defined in 3D space is distinct from the physical layout of node cores described in two-dimensional (2D) space for various embodiments described herein.

In the context of the present application, these adjacency relationships are used to implement similarity-aware assignment, such that computational elements expected to interact more frequently are placed at smaller angular separation and/or across paired indices to reduce routing overhead. In some examples, computational elements may exhibit higher similarity with respect to one or more other computation elements, or vice versa. In other examples, computational elements may exhibit higher similarity if the similarity satisfies a fixed or variable threshold.

In some embodiments, a mapping relationship between a three-dimensional dual-helix logical node layout and a planar coordinate frame is established by projecting each node from its three-dimensional position onto a two-dimensional representation that preserves adjacency and cross-strand pairing. The planar representation may be used by a placement controller to compute and store an assignment map from computational elements to node addresses, and to estimate physical distance, hop count, and/or communication cost associated with executing interactions among assigned computational elements.

In some embodiments, the dual-helix node coordinates are represented using parametric equations such as x(θ)−r·cos(θ), y(θ)=r·sin(θ), and z(θ)=(p·θ)/(2π), where r is the helix radius, p is the z-direction pitch, and θ is an angular coordinate. A planar mapping may use X′=z and Y′=(r·θ) mod (2π·r) or other equivalent coordinate transformations. In the present application, the coordinate representation may be used to quantify angular separation, neighborhood membership, and similarity-weighted placement cost for assigning computational elements to nodes.

The mapping relationship between the dual-helix logical node layout 200 and the planar mapping coordinate frame 300 is established by projecting each node from its three-dimensional position onto the two-dimensional plane in a manner that preserves adjacency and logical pairing. In some embodiments, the dual-helix logical node layout 200 provides the starting three-dimensional coordinates for each A-helix chain and B-helix chain node, and the projection process defines the layout in X′ and Y′ such that, with only a few exceptions, similarly-indexed nodes that are proximate to each other in the 3D layout retain relative spatial proximity in the 2D layout.

The parametric equations for the 3D helix may be expressed as x(theta)=r*cos(theta), y(theta)=r*sin(theta), and z(theta)=(p*theta)/(2*pi), where r is the helix radius, p is the z-direction pitch, and theta is the angular coordinate. The planar projection may use mapping equations such as X′=z and Y′=(r*theta)mod(2*pi*r), with the modulo function in the Y′ mapping ensuring that nodes from different turns of the helix are distributed within a fixed vertical range in the planar layout. The preservation of logical connectivity and adjacency in the projected layout is achieved by maintaining the adjacency of nearest-neighbor quantum nodes along each chain (A-helix chain and B-helix chain), as well as the vertical alignment of cross-chain node pairs (A_i and B_i).

FIG. 3 is view illustrating an example spiral-unwrapped placement of quantum nodes on the A-helix chain and B-helix chain and links 301 and 302 between the quantum nodes, arranged in accordance with at least one embodiment herein. In FIG. 3, the links 301 couple quantum nodes which are nearest neighbors within the same slanted column. The links 302 provide connections between nodes in adjacent slanted columns that are substantially aligned in the vertical (Y′) direction. For instance, the links 301 may be established between nearest-neighbor nodes such as B5 and B6 or between A19 and A20, while the links 302 may provide cross-chain connections between nodes such as A1 and B1 or B20 and A20, where the nodes are located in adjacent slanted columns and have the same index number.

In some embodiments, the links 301 and the links 302 may be configured to provide optical signal routing between quantum nodes. The links 301 and the links 302 may include in-plane waveguide paths and vertical optical interconnects for cross-layer communication. Examples of such photonic routing layers may include silicon nitride waveguide layers, silicon dioxide cladding layers, or other dielectric waveguide structures configured for low-loss optical transmission. Other links may be made between other of the quantum nodes than those illustrated. For example, links may be formed between the A1 and A3. In these and other embodiments, links may be formed so that any two nodes may be reached in O(log N) hops by utilizing both intra-strand neighbor links and inter-strand links, thereby achieving logarithmic-diameter connectivity across the entire quantum processing architecture.

In the context of similarity-aware placement, such links provide a connectivity graph used to place computational elements so that high-similarity pairs are mapped to directly connected nodes or low-hop neighborhoods.

In some embodiments, the links 301 and 302 are configured to provide optical signal routing between quantum nodes, including in-plane waveguide paths and/or vertical optical interconnects for cross-layer communication. Other links may be formed to provide additional shortcut connectivity. In some embodiments, the dual-helix interconnect scheme supports reaching any node within O(log N) hops by utilizing both intra-strand neighbor links and inter-strand links. In the present application, the placement controller may incorporate hop distance and/or link classes into a similarity-aware objective function, thereby reducing expected routing operations during execution.

### Quantum Node Model and Spatial Organization

In some embodiments, each quantum node may be associated with a spatial coordinate derived from its position along a helix in a dual-helix structure, such as illustrated in FIGS. 2 and 3. The spatial coordinate may include an angular position θ and, optionally, corresponding Cartesian coordinates (x, y, z). In one embodiment, the angular position θ may be determined according to θi=i·Δθ, where i represents a node index and Δθ represents an angular increment between successive nodes. The Cartesian coordinates may be derived from the angular position according to xi=r·cos(θi), yi=r·sin(θi), and zi=(h/2π)·θi, where r represents a helix radius and h represents a helix pitch. The spatial coordinate may provide a deterministic mapping between node index and physical position within a three-dimensional helical structure.

The spatial coordinate may be used for addressing, routing, scheduling, or organizing quantum operations. In one embodiment, the spatial coordinate may serve as an addressable quantum register that may be manipulated by quantum gates. The spatial coordinate may facilitate efficient routing by allowing quantum operations to be scheduled based on physical proximity of nodes, thereby reducing communication overhead and circuit depth. Alternately or additionally, such spatial relationships may be used to constrain or prioritize quantum operations, reduce routing overhead, or organize execution.

In some embodiments, a dual-helix structure and the associated quantum nodes on the helix structure may be divided into segment. Each segment may comprise a contiguous group of quantum nodes along a helix chain. The segment boundaries may be defined by angular positions along the helical structure.

The selection of segments, e.g., the segment boundaries, may be based on the computational requirements of an quantum artificial intelligence task. The number of quantum nodes in each segment may be determined by the angular span of the segment. For example, a segment spanning an angular range of Δθ may contain Nsegment quantum nodes, where Nsegment may be calculated as Δθ divided by the angular step between adjacent nodes. The angular step between adjacent nodes may be denoted as δθ. The relationship may be expressed as Nsegment=Δθ/δθ. The angular span Δθ of each segment may be selected based on the coherence time of the quantum nodes, the complexity of the quantum operations to be performed within the segment, and the desired level of parallelism across segments.

The number of quantum nodes in each segment may range from a minimum of two nodes to a maximum equal to the total number of nodes in a complete helical turn. A complete helical turn may correspond to an angular span of 2π radians. The number of nodes per complete turn may be denoted as Nturn. The maximum number of nodes in a segment may therefore be Nturn. The minimum number of nodes in a segment may be two nodes, which may enable the simplest form of quantum entanglement operations between adjacent nodes within the segment.

The selection of segment boundaries may be performed algorithmically based on the structure of a quantum circuit to be executed. For example, a quantum circuit may comprise multiple layers of quantum gates. Each layer may correspond to a set of quantum operations that may be executed in parallel. The segment boundaries may be aligned with natural boundaries in the quantum circuit structure. For example, segment boundaries may be placed between layers of quantum gates that require synchronization or aggregation of results. The segment boundaries may also be placed to minimize the number of quantum operations that span across segment boundaries, thereby reducing the communication overhead between segments.

The segments may be of equal size, with each segment containing the same number of quantum nodes. Alternatively, the segments may be of varying sizes, with different segments containing different numbers of quantum nodes. The size of each segment may be determined based on the computational load assigned to that segment. Segments assigned more computationally intensive tasks may contain more quantum nodes. Segments assigned less computationally intensive tasks may contain fewer quantum nodes. This variable segment sizing may enable load balancing across a dual-helix structure.

The segments may be contiguous along the helix chain, with each segment immediately following the previous segment in the angular coordinate. Alternatively, the segments may be non-contiguous, with gaps between segments. The gaps between segments may contain quantum nodes that are not assigned to any segment during a particular computational phase. These unassigned nodes may be reserved for error correction operations, calibration operations, or future computational tasks.

The segments may be defined on a single helix chain, such as the first helix chain 102A or the second helix chain 102B. Alternatively, the segments may span across both helix chains, with each segment containing quantum nodes from both the first helix chain 102A and the second helix chain 102B. Segments that span across both helix chains may utilize the rung couplers to enable quantum operations between nodes on different helix chains within the same segment.

In some embodiments, the segment boundaries may enable parallel execution of quantum operations across multiple segments. In these and other embodiments, different segments may be prepared for different computational subtasks.

Note that while the dual-helix structure may be divided into segments in some embodiments, other embodiments may not have the dual-helix structure divided into segments.

### Quantum State Encoding and Positional Modes

In some embodiments, quantum states processed by the architecture may include one or more encoding dimensions. These dimensions may include, by way of example and not limitation, amplitude, phase, polarization, frequency, orbital angular momentum, or other degrees of freedom. Each encoding dimension may provide an independent channel for representing information within the quantum state. The combination of multiple encoding dimensions may enable high-dimensional quantum state representations that may support complex computational tasks.

In some embodiments, the spatial coordinate of a quantum node may serve as an additional encoding dimension. The spatial coordinate may be derived from the angular position θ of the quantum node along the helix. The spatial coordinate may be represented as a positional mode within the quantum state. The positional mode may be expressed as |θ [symbol] , where θ corresponds to the angular position of the quantum node. The positional mode may be treated as a quantum register that may be manipulated by quantum operations. The positional mode may enable position-dependent quantum operations that may exploit the geometric structure of the double-helix architecture.

Note that the use of positional modes is optional and may vary depending on the quantum algorithm or workload being executed.

As an example of positional modes in the dual-helix structure 102, each quantum node may store a quantum state that may include orbital angular momentum (OAM) modes, polarization states, phase values, and/or spatial position information. The OAM modes may be initialized to specific angular momentum values l. The polarization states may be initialized to horizontal, vertical, left-circular, or right-circular polarization. The phase values may be initialized to specific phase angles φ. The spatial position information may be encoded in a positional mode corresponding to the node's angular coordinate θ. For example, each quantum node positioned along the two intertwined helices may be assigned a deterministic spatial coordinate (xi, yi, zi) derived from the angular position θi according to the parametric equations xi=r·cos(θi), yi=r·sin(θi), and zi=(h/2π)·θi, where r denotes the helix radius, h denotes the pitch, and θi=i·Δθ represents the angular coordinate of node i. The spatial coordinate i may function simultaneously as a logical register within a quantum state representation |l, p, φ; θ [symbol] and as a physical address identifying the geometric location of the node within the three-dimensional helical structure.

In some embodiments, the dual nature of the spatial coordinate may enable quantum circuits to perform position-dependent operations by applying phase gates proportional to θi, selecting neighboring nodes based on angular proximity, or routing quantum information along paths determined by the helical geometry. The deterministic mapping between node index i and spatial position θi may provide a consistent addressing scheme that may be exploited by compilation algorithms to minimize routing overhead and by runtime schedulers to distribute computational tasks across spatially localized segments of the helix.

In some embodiments, the spatial coordinate may be encoded into the quantum state through positional phase tagging, wherein a unitary operator Upos(k)=exp(ikθi) may be applied to each node to embed the angular position as a phase factor. The resulting state e\hat{ }(ikθi)|l, p, φ; θ [symbol] may carry positional information that may be accessed through interference-based operations or Fourier transforms performed across the θ-register. The positional phase tagging may enable circuits to implement convolution-like operations by coupling nodes at positions θ and θ±kΔθ, where the phase relationship between coupled nodes may encode spatial frequency components analogous to classical convolutional kernels.

In some embodiments, the positional mode may allow for gate connections restrictions to physically adjacent or geometrically proximate nodes, thereby reducing the need for long-range SWAP operations that typically introduce errors and increase circuit depth in planar quantum architectures.

In some embodiments, the positional mode may allow for segment-scoped parameter tying mechanism that may enforce shared trainable parameters across all nodes in a segment, such that gradient updates computed at individual nodes may be averaged to produce a single parameter update applied uniformly throughout the segment. The positional mode may thus serve as both a quantum degree of freedom that may be manipulated by gates and measurements, and as a classical index that may be used by compilers and schedulers to organize quantum operations according to the physical topology of the double-helix architecture.

### Execution, Scheduling, and Parallelism Framework

In some embodiments, the quantum computing architecture as discussed in this disclosure may be organized into layers such that no quantum node participates in more than one operation within a given layer. As a result, each layer may represent a set of quantum operations that may be executed in parallel without conflict, where conflict may be defined as two or more operations attempting to act on the same quantum node simultaneously. The organization into layers may enable efficient parallel execution of quantum operations while maintaining the integrity of quantum states at each node. The layer structure may be determined by analyzing the connectivity graph of the quantum computing architecture and identifying sets of operations that may be performed concurrently without violating the constraint that each node participates in at most one operation per sublayer.

The architecture may support multiple layers within a single layer of quantum computation, referred to as sublayers, where each sublayer may correspond to a distinct set of non-conflicting operations. The number of sublayers required for a given layer of quantum computation may depend on the connectivity pattern of the operations and the physical topology of the quantum nodes along the intertwined helices. Operations within a sublayer may be executed simultaneously across different quantum nodes, thereby reducing the overall execution time for the layer.

In some embodiments, the layer organization may be particularly advantageous in architectures where quantum nodes are spatially distributed along helical structures, as the geometric arrangement may naturally suggest groupings of operations that may be performed in parallel without interference. Note that the scheduling mechanisms described herein are provided as illustrative examples of how quantum operations may be coordinated on a spatially organized architecture. The architecture does not require any particular scheduling strategy, and different scheduling approaches may be used depending on the algorithm, workload, or hardware implementation.

### Parameter Handling and Optimization Support

Furthermore, the quantum computing architecture described herein may support various approaches to parameter management during quantum operations. Parameters in quantum circuits may include rotation angles, phase values, coupling strengths, and other adjustable quantities that influence the behavior of quantum gates and operations. The manner in which parameters are handled may affect the efficiency, accuracy, and scalability of quantum computations performed on the architecture.

In some embodiments, parameters may be managed at different levels of granularity within the quantum computing architecture. At a local level, individual quantum nodes may maintain parameter values that govern the behavior of quantum gates applied at those nodes. At a segment level, groups of quantum nodes organized into segments may share parameter values, thereby reducing the total number of independent parameters that must be managed and optimized. At a global level, parameter values may be coordinated across multiple segments or across the entire quantum computing architecture to maintain consistency and coherence in quantum operations. The hierarchical organization of parameter management may enable efficient scaling of quantum computations while maintaining control over the behavior of individual quantum operations. Different levels of parameter management may be employed depending on the specific requirements of the quantum algorithm being executed, the characteristics of the quantum hardware, and the desired trade-offs between computational efficiency and operational flexibility.

In some embodiments, parameter aggregation may be performed classically, quantum-mechanically, or using hybrid approaches. Note that the dual-helix architecture is not limited to any particular optimization algorithm or parameter update rule. Gradient-based methods, reinforcement learning techniques, heuristic optimizers, or other optimization approaches may be used depending on the application.

The parameter handling mechanisms described herein are intended to illustrate architectural support for parameterized quantum algorithms and do not define a specific optimization method unless expressly claimed.

### Illustrative AI Workflows Supported by the Architecture

By way of example only, the disclosed architecture may support a variety of artificial intelligence workflows, including but not limited to:
Quantum neural network training and inference
Variational quantum optimization for machine learning or combinatorial problems
Similarity-based inference or data placement
Hybrid quantum-classical execution pipelines

These workflows are provided as non-limiting examples. The architecture may support other quantum algorithms and workloads beyond artificial intelligence applications.

FIG. 4 illustrates an example process flow 400 for quantum computing using a dual-helix quantum architecture, arranged in accordance with at least one embodiment herein. The process flow 400 may be executed by the system 100 of FIG. 1A, utilizing the dual-helix structure 102 and associated components. The process flow 400 may enable quantum neural network training, variational quantum optimization, or other quantum artificial intelligence tasks by leveraging the spatial topology and multi-dimensional encoding capabilities of a dual-helix architecture.

The process flow 400 may include an initialization/design phase 402, an orchestration phase 406, an execution phase 408, a parameter adjustment phase 410, an error correction phase 412, a convergence/evaluation phase 414, and an inference and output phase 416. Each phase may be performed sequentially or with partial overlap depending on the specific quantum computing task and hardware configuration.

The process flow 400 of FIG. 4 may provide a comprehensive framework for executing quantum artificial intelligence workloads on the dual-helix quantum architecture described herein. The process flow 400 may enable end-to-end processing of quantum neural network training, variational quantum optimization, and quantum machine learning tasks by leveraging the spatial topology and multi-dimensional encoding capabilities inherent to the double-helix structure.

In some embodiments, the process flow 400 provides an end-to-end framework in which similarity-aware placement reduces routing overhead by aligning task interaction locality with physical node locality. For example, the process flow 400 may reduce circuit depth by reducing long-range state transfers and by preferentially executing interaction operations among computational elements placed at reduced angular separation or connected by cross-strand couplers.

In some embodiments, the process flow 400 supports concurrent execution across regions of the dual-helix topology by distributing computational elements into multiple neighborhoods or clusters that are mapped to different angular intervals and/or different helix chains. Such distribution may improve throughput by reducing contention for shared links and by enabling multiple interaction groups to execute with reduced cross-group communication.

In some embodiments, the computational elements may include data from a dataset or variables from a computational model. For example, the computational elements may represent input data values, intermediate computation results, or model parameters that participate in quantum operations. For data-based computational elements, each element may correspond to a feature vector, a data point, or a tensor component from the input dataset. For model-based computational elements, each element may correspond to a weight parameter, a bias term, or a trainable coefficient within a quantum neural network or variational quantum circuit.

In some embodiments, an initialization/mapping phase includes determining similarity among computational elements and generating an assignment map that associates each computational element with a node address. The mapping phase may also include establishing or verifying cross-strand coupling availability for paired indices and/or selecting neighborhood boundaries used to localize interactions among high-similarity elements.

In some embodiments, the initialization/mapping phase prepares node resources based on the assignment map, including initializing quantum nodes intended to store computational elements and configuring routing elements to preferentially support low-hop transfers within neighborhoods. State initialization may be performed using any suitable physical mechanism depending on implementation (e.g., photonic, superconducting, ion trap), and the present application does not require any particular initialization state beyond enablement of subsequent operations.

In some embodiments, similarity-aware assignment is used to reduce the number of long-range entangling operations required during execution. For example, when interacting computational elements are placed on nodes connected by neighbor links or rung couplers, interactions can be implemented using lower-hop operations compared to placements that separate interacting elements across distant turns.

In some embodiments, communication overhead may be reduced by selecting assignments that minimize a similarity-weighted distance measure, where the distance measure is defined in terms of angular separation, hop count in a connectivity graph, physical path length, and/or estimated link fidelity. High-similarity element pairs may be placed to minimize this measure, while low-similarity element pairs may be placed with lower priority.

In some embodiments, an ordering or clustering of computational elements may be made based on similarity and then the ordered elements may be assigned to nodes along increasing angular coordinates on one or both helices. The assignment may be performed to keep clustered elements within bounded angular spans, thereby reducing expected state transfers across cluster boundaries.

In some embodiments, the assignment supports workloads that include repetitive interaction patterns by placing stable interaction groups into persistent neighborhoods. The assignment may also support workloads with time-varying interaction patterns by enabling remapping of select elements or clusters between execution intervals.

In some embodiments, inference-like or decision-like workloads are represented as interactions among computational elements that correspond to variables, constraints, or data-derived features. The present application does not require any particular model class; rather, the similarity-aware placement mechanism is applicable to any workload in which element-to-element interaction affinity can be quantified.

During execution, quantum operations may be performed to implement interactions among computational elements stored at assigned nodes. When interacting elements have been co-located by similarity-aware placement, the operations may require fewer routing steps and fewer long-range state transfers, thereby reducing execution overhead.

In some embodiments, similarity between computational elements may be quantified using a similarity function that measures the degree of relatedness or correlation between pairs of elements. For data vectors, the similarity function may compute a distance metric such as Euclidean distance, cosine similarity, or kernel-based similarity measures. For model variables, the similarity may be determined by computing connectivity scores that reflect the frequency or strength of interactions between variables during computational operations. The connectivity score for a variable may be calculated by summing the absolute values of coupling coefficients between that variable and all other variables in the model.

For example, in some embodiments, similarity is represented as an interaction graph whose nodes represent computational elements and edges represent affinity or interaction strength. The placement controller may use the interaction graph to form clusters, partitions, or ordered sequences and then map those structures onto the dual-helix topology to preserve locality.

As another example, in some embodiments, similarity is computed from an adjacency matrix or other pairwise relationship representation. The adjacency matrix may be analyzed using clustering, spectral methods, thresholding, or heuristic methods to identify groups of elements that should be placed in proximity on the dual-helix topology.

In some embodiments, an assignment map may be constructed that maps each computational element to a node identifier and optionally stores metadata such as cluster membership, neighborhood identifier, and expected interaction partners. The assignment map may be used by the central control module to configure routing, allocate QPU resources, and evaluate whether remapping is warranted.

In some embodiments, alternative placements may be evaluated by estimating total routing cost as a function of (i) similarity weights and (ii) node-to-node distance in the dual-helix topology. A placement may be selected that reduces an objective function representing expected communication overhead during execution.

The mapping and execution framework may involve specific hardware components including controller circuitry, routing components, and readout components. In some embodiments, measurement results and link-quality indicators are collected to estimate effective routing cost, link success probability, and/or error rates that are relevant to placement quality.

In some embodiments, computational elements are distributed across both helix chains to balance resource usage while maintaining locality. For example, a first cluster may be mapped to a contiguous interval on the first helix chain and a second cluster may be mapped to a contiguous interval on the second helix chain, with cross-cluster interactions preferentially mapped to cross-strand paired indices when feasible.

In some embodiments, the placement controller defines neighborhood boundaries within the dual-helix topology. Each neighborhood may include a contiguous group of nodes on one helix chain and/or a paired group across both helix chains. Neighborhood boundaries may be selected to reduce cross-neighborhood routing for high-similarity interactions.

In some embodiments, the number of nodes assigned to a neighborhood is selected based on cluster size, expected interaction density, and available node resources. Neighboring clusters may be placed in adjacent angular ranges to reduce cross-cluster hop distance when interactions between the clusters exceed a threshold.

In some embodiments, neighborhood sizes range from a minimum of two nodes to a maximum corresponding to a full helical turn or another defined angular span. The minimum supports localized interactions, and larger spans support larger clusters while maintaining bounded routing cost.

In some embodiments, neighborhood boundaries and assignments are computed algorithmically using the similarity graph and the connectivity of the dual-helix topology. The placement controller may attempt to reduce the number of edges in the similarity graph that cross neighborhood boundaries to reduce cross-neighborhood routing operations.

In some embodiments, neighborhood sizes are uniform for simplicity. In other embodiments, neighborhood sizes vary to account for differences in cluster size or interaction intensity, enabling improved load balancing while maintaining locality for high-similarity interactions.

In some embodiments, certain nodes or regions are reserved as unassigned or spare capacity to support later remapping, maintenance, or avoidance of degraded links. Such reserved capacity may reduce disruption when remapping is triggered.

In some embodiments, neighborhoods may be defined on a single helix chain or may span both helix chains via cross-strand couplers. Cross-strand neighborhoods may be preferred for interaction patterns that benefit from paired indices or frequent cross-chain interactions.

In some embodiments, an optional aggregator node or coordination node may be assigned to a neighborhood to collect measurement outcomes and/or to coordinate routing among nodes within the neighborhood. The aggregator node need not perform gradient aggregation and is used in this application for monitoring, coordination, and placement evaluation.

In some embodiments, the aggregator node is positioned to minimize maximum hop distance within the neighborhood, for example at a central angular position in the neighborhood. Such placement reduces monitoring and coordination latency within the neighborhood.

In some embodiments, neighborhoods operate largely independently during execution intervals when cross-neighborhood interactions fall below a threshold. When cross-neighborhood interactions are required, they may be scheduled according to available links, but the present application does not require any particular scheduling approach.

After completion of a computation interval, the system may collect measurement results and routing statistics (e.g., hop counts used, transfer success rates, link fidelity estimates) and may compute an observed communication cost for the current assignment map.

In some embodiments, a hierarchical coordination scheme may be used to collect routing statistics and measurement outcomes from multiple neighborhoods. Such coordination may be used to evaluate whether a new placement map would reduce communication cost, without requiring any particular optimization or training algorithm.

In some embodiments, neighborhoods exchange summary information indicating interaction intensity across neighborhood boundaries. This information may be used to trigger targeted remapping of a limited number of computational elements to reduce cross-neighborhood communication.

In some embodiments, the system computes a global placement quality metric based on observed routing cost, observed error rates, and similarity-weighted interaction counts. The metric may be used to compare the current placement to candidate alternative placements.

In some embodiments, the architecture supports dynamic reconfiguration of neighborhood boundaries and element-to-node assignments. Dynamic reconfiguration may be performed in response to changing similarity relationships, observed communication overhead, or detected hardware constraints (e.g., degraded links or unavailable nodes).

During dynamic reconfiguration, neighborhood boundaries may be adjusted by changing the angular span assigned to a neighborhood or by reassigning portions of a neighborhood to adjacent neighborhoods. The adjustment may be performed by updating mapping tables and configuration registers associated with routing elements and node addressing.

When neighborhood boundaries are reconfigured, the assignment of computational elements to node addresses may also change. In some embodiments, a computational element is reassigned from a first node to a second node in a different neighborhood when the reassignment reduces similarity-weighted routing cost and/or avoids a degraded link region.

In some embodiments, neighborhood coordination nodes may be reassigned, activated, or deactivated based on which neighborhoods are active, which links are healthy, and which neighborhoods have high interaction intensity. Reassignment may be performed to balance monitoring overhead and to maintain stable routing performance.

In some embodiments, the system prepares quantum states that encode computational elements on assigned nodes using any suitable encoding scheme. For example, states may include one or more degrees of freedom such as OAM modes, polarization states, phase values, and/or other quantum state parameters, depending on the qubit modality. In the present application, such encoding is described for enablement and may be used to represent computational elements after similarity-aware placement.

In some embodiments, the spatial coordinate of a node (e.g., angular coordinate θ) is used as an address and may optionally be incorporated into state preparation to maintain consistency between a mapping table and a physical placement. The mapping between element identifier and node coordinate provides a deterministic addressing scheme for subsequent interactions among placed elements.

In some embodiments, positional tagging (e.g., phase tagging based on θ) may be used to assist in routing, verification of correct placement, or identification of neighborhood membership. Positional tagging is optional and is not required for similarity-aware placement, but may improve robustness and traceability of placed elements.

In some embodiments, gate connections are restricted or prioritized to nodes that are physically adjacent or within bounded hop distance, such that similarity-aware co-location yields immediate reductions in routing operations compared to non-local placement.

Following state preparation, input datasets or model variables may be assigned to quantum nodes using the similarity-aware assignment map. The assignment map determines which computational element occupies which node position and may be stored in a mapping table accessible to the central control module.

### Similarity-Based Assignment of Computational Elements

In some embodiments, assignment of computational elements to quantum nodes is determined by analyzing the structure of a computational task to identify similarity relationships among the computational elements. Such similarity relationships may represent expected interaction frequency, correlation strength, dependency magnitude, or co-occurrence likelihood during execution. Based on these similarity relationships, computational elements are assigned to quantum nodes positioned along the dual-helix architecture so as to reduce geometric separation between elements that are expected to interact.

In some embodiments, the resulting assignments are stored in a mapping table that associates each computational element identifier with a corresponding quantum node position, such as an angular coordinate θᵢ or a helix-chain identifier. Quantum state preparation circuitry may reference the mapping table to encode or load each computational element at its assigned node location. The assignment may remain fixed throughout a computation cycle or may be updated between cycles in response to observed communication cost, detected hardware constraints, or changes in similarity relationships.

### Similarity Metrics and Graph Construction

In some embodiments, similarity between computational elements is quantified using a similarity function that measures relatedness or correlation between element pairs. For data-based elements, similarity functions may include Euclidean distance, cosine similarity, kernel-based measures, or statistical correlation metrics. For model- or constraint-based elements, similarity may be determined using connectivity scores that reflect the number or strength of interactions between elements during execution. A connectivity score for an element may be computed as the sum of absolute interaction weights between that element and other elements in the system.

In some embodiments, a similarity graph is constructed in which nodes represent computational elements and weighted edges represent similarity values exceeding a defined threshold. This graph representation is used to guide placement by preserving local similarity structure during assignment to physical node positions.

### Ordering, Clustering, and Helix-Aware Mapping

In some embodiments, computational elements are ordered or clustered based on similarity relationships prior to assignment. The ordering may be produced by applying graph traversal or ordering algorithms to the similarity graph, including depth-first traversal, breadth-first traversal, spectral ordering using eigenvectors of a graph Laplacian, or other clustering and partitioning techniques.

The ordered or clustered computational elements are then mapped sequentially or by cluster to quantum nodes along the dual-helix structure. In some embodiments, the first elements in the ordering are assigned to nodes at smaller angular coordinates, and subsequent elements are assigned to nodes at progressively increasing angular positions. This approach places highly similar elements at reduced angular separation, thereby reducing the expected number of routing hops required for interaction.

### Single-Helix and Cross-Helix Placement Strategies

In some embodiments, computational elements with high mutual similarity are preferentially assigned to quantum nodes on the same helix chain. Placement on a single helix chain reduces physical distance and minimizes the need for cross-helix communication during execution.

In other embodiments, computational elements are partitioned across the first helix chain and the second helix chain to balance resource usage while preserving locality. For example, a first subset of highly similar elements may be assigned to a contiguous angular interval on the first helix chain, while a second subset may be assigned to a contiguous angular interval on the second helix chain. Partitioning may be determined using graph partitioning algorithms that minimize similarity-weighted edges crossing between helix chains while maintaining balanced node counts.

### Example: Image-Based Computational Elements

As an illustrative example, an image tensor may be partitioned into computational elements corresponding to spatial patches of the image. The image may be divided into patches of size P×P, where P is selected based on available quantum nodes and desired locality. Each patch is treated as a computational element.

The patches may be ordered according to a spatial traversal pattern that preserves locality, such as row-major order, column-major order, or a space-filling curve. Adjacent patches in the original image are assigned to quantum nodes that are proximate along the helical structure, such that patches that are spatially adjacent in the image correspond to nodes that are close in angular position θ along the helix. This placement reduces communication overhead for operations involving neighboring patches.

In some embodiments, assignment alternates between the A-helix chain and the B-helix chain, such that consecutive patches are placed on opposite helices. This enables direct cross-strand interactions between adjacent patches using rung couplers while maintaining bounded angular separation.

### Multi-Dimensional Encoding (Placement-Neutral)

In some embodiments, computational elements are encoded into quantum states using one or more physical degrees of freedom, such as orbital angular momentum modes, polarization states, phase values, or other modality-dependent parameters. Such encoding is orthogonal to the placement mechanism and does not alter the similarity-aware assignment itself.

For example, different computational elements may be encoded into distinct OAM modes or polarization states while being placed at node positions determined by similarity relationships. The placement mechanism operates independently of the specific encoding scheme. Runtime Observation and Optional Remapping

In some embodiments, communication statistics are collected during execution, including hop counts, link utilization, or state-transfer success rates. These measurements may be used to estimate realized communication cost for the current placement.

If the observed cost exceeds a threshold or if similarity relationships change, the system may compute an updated placement map and reassign a subset of computational elements to new node positions between computation cycles. Remapping may be constrained to local neighborhoods to minimize disruption.

### Technical Advantages

The similarity-aware placement mechanisms disclosed herein provide several technical advantages, including:
Reduced inter-node communication overhead by co-locating interacting elements.
Reduced routing depth by aligning similarity structure with physical adjacency.
Improved scalability by bounding interaction distance as system size increases.
Hardware-agnostic applicability across photonic, superconducting, or other quantum modalities.
Compatibility with static or dynamically reconfigured dual-helix topologies.

### Example of Similarity-Aware Execution Mapping

An example of a similarity-aware execution arrangement may be illustrated using a quantum circuit mapped onto a dual-helix quantum architecture comprising a plurality of quantum nodes distributed across two intertwined helical strands. In one illustrative embodiment, the architecture includes thirty-two quantum nodes, with sixteen nodes positioned on a first helix chain and sixteen nodes positioned on a second helix chain. Computational elements that exhibit higher similarity or interaction frequency may be assigned to quantum nodes that are proximate in angular position along the same helix or across paired helix positions.

In this example, a first subset of computational elements may be assigned to quantum nodes A0 through A7 on the first helix chain, while a second subset of computational elements may be assigned to quantum nodes B0 through B7 on the second helix chain. Additional computational elements may be assigned to nodes A8 through A15 and B8 through B15, respectively, such that elements expected to interact are positioned at reduced angular separation or connected through direct cross-strand rung couplers.

### Similarity-Aware Assignment and Locality-Preserving Execution

In some embodiments, assignment of computational elements to quantum nodes is determined by analyzing the structure of a computational task to identify similarity relationships among the computational elements. Similarity relationships may represent statistical correlation, interaction frequency, connectivity strength, or spatial adjacency within the task representation. Based on these relationships, computational elements are assigned to quantum nodes positioned along two intertwined helices such that elements exhibiting higher similarity are mapped to quantum nodes with reduced angular separation.

In some embodiments, similarity between computational elements is quantified using one or more similarity functions. For data-based elements, similarity functions may include distance metrics such as Euclidean distance, cosine similarity, or kernel-based similarity measures. For model- or graph-based elements, similarity may be determined using connectivity scores that reflect interaction strength or coupling frequency between elements. Connectivity scores may be computed by aggregating interaction weights or coupling coefficients associated with each element.

Computational elements may be ordered according to similarity prior to assignment. In some embodiments, a similarity graph is constructed in which nodes represent computational elements and edges represent similarity relationships exceeding a threshold. A graph traversal or ordering algorithm may be applied to generate an ordering that preserves local similarity structure. The ordered elements are then sequentially mapped to quantum nodes along the helical structure, such that elements with higher mutual similarity occupy quantum nodes at adjacent or nearby angular coordinates.

In some embodiments, similar computational elements are preferentially assigned to quantum nodes on the same helix chain to reduce cross-helix communication. Alternatively, when interaction across two subsets is required, elements may be assigned to paired nodes connected by cross-strand rung couplers to enable direct quantum interactions with minimal routing overhead. Partitioning of computational elements between helix chains may be performed using graph partitioning algorithms that minimize inter-partition similarity edges while balancing node utilization.

### Illustrative Examples

In one example, an image tensor is partitioned into patches, each patch representing a computational element. Patches that are spatially adjacent in the original image are assigned to quantum nodes with adjacent angular positions along the helix. This similarity-preserving assignment reduces the physical distance over which quantum information must be exchanged during execution, thereby reducing circuit depth and communication overhead.

In some embodiments, the initialization/design phase 402 may include other operations. For example, the initialization/design phase 402 may include calibration of quantum gates and measurement apparatus, preparation of error correction infrastructure, and loading of pre-compiled quantum circuits or circuit templates. Calibration may involve characterization of gate fidelities, measurement of coherence times, and determination of optimal control parameters, with calibration data stored in lookup tables for use during circuit execution. Error correction infrastructure may include stabilizer measurement circuits, syndrome extraction logic, and error decoding algorithms configured based on the helical structure geometry. Pre-compiled circuits representing standard operations such as quantum Fourier transforms or neural network layer implementations may be loaded from a circuit library to reduce compilation time.

The orchestration phase 406 may follow the initialization/design phase 402. Generally, the orchestration phase 406 may include compilation and scheduling operations that transform the initialized quantum system into an executable configuration for the dual-helix architecture. Compilation may involve translating logical quantum circuits into physical gate sequences that exploit the geometric properties of the helical structure. The compilation process may map logical qubits to physical quantum nodes positioned along the two intertwined helices based on the spatial coordinates and connectivity patterns established during initialization.

In some embodiments, the orchestration phase 406 may include a mapping algorithm for mapping layers of a network onto quantum nodes positioned along the two intertwined helices. The mapping method may support various quantum neural network architectures including feedforward networks, convolutional networks, and recurrent networks. For convolutional architectures, the mapping may assign convolutional kernels to localized groups of quantum nodes, with kernel parameters shared across multiple spatial positions through segment-scoped parameter tying. For recurrent architectures, the mapping may assign recurrent connections to rung links that connect nodes at different vertical positions along the helix, enabling temporal dependencies to be encoded in the spatial structure.

The orchestration phase 406 may further include resource allocation operations that distribute computational resources across the quantum computing architecture. The resource allocation operations may include assigning classical control resources to specific segments of the helical structure. The resource allocation operations may include allocating measurement apparatus to designated aggregator nodes. The resource allocation operations may include reserving quantum memory resources for intermediate state storage during multi-layer quantum neural network execution.

The execution phase 408 may follow the orchestration phase 406 and may involve the actual running of quantum circuits on the quantum computing architecture. The execution phase 408 may include applying quantum gates to quantum nodes, performing measurements, and collecting results according to the schedules and mappings established during the orchestration phase 406. The execution phase 408 may leverage the spatial topology of the double-helix structure to enable parallel execution of quantum operations across multiple segments while maintaining coherence and minimizing errors.

In some embodiments, quantum gate operations are executed preferentially between quantum nodes that are adjacent along a helix or connected by rung couplers. Single-qubit operations are applied locally at assigned nodes, and multi-qubit operations are restricted to geometrically proximate node pairs whenever possible. Long-range routing is avoided or minimized by construction of the assignment.

The similarity-aware execution framework operates independently of training procedures, gradient computation, or parameter optimization. The disclosed methods apply equally to inference-only workloads, constraint satisfaction problems, graph algorithms, and other quantum computations where interaction locality can be identified prior to execution.

### Locality-Preserving Gate Execution

In some embodiments, quantum gate operations associated with computational elements assigned to neighboring nodes may be executed using locality-preserving gate connections. For example, single-qubit gates may be applied independently to individual quantum nodes, while two-qubit entangling gates may be applied preferentially between quantum nodes that are adjacent along a helix or directly connected by a rung coupler. By restricting gate execution to physically adjacent or geometrically proximate nodes, the architecture reduces the need for long-range routing operations.

In some embodiments, entangling operations between quantum nodes positioned on different helix chains may be executed using cross-strand rung connections that couple corresponding node pairs. Because each quantum node may be associated with at most one corresponding rung connection, such cross-strand operations may be executed without introducing contention or routing conflicts.

### Adaptation to Heterogeneous Gate Types

In some embodiments, the similarity-aware execution framework is not limited to single-qubit or two-qubit gates. Multi-qubit gate operations involving three or more quantum nodes may be decomposed into sequences of locality-preserving single-qubit and two-qubit operations that respect the similarity-based placement of computational elements. Measurement operations may be executed at quantum nodes associated with computational outputs without requiring relocation of quantum states across distant nodes.

### Robustness to Hardware Variability

In some embodiments, execution paths may be adjusted in response to detected degradation of specific quantum nodes or interconnects. Hardware monitoring components may identify nodes or connections exhibiting reduced fidelity, and execution of quantum operations may be redirected to alternative neighboring nodes that preserve similarity-based locality. Such adjustments may be performed without altering the underlying similarity-based assignment of computational elements.

### Technical Advantages of Similarity-Aware Execution

The similarity-aware execution approach described herein provides several technical advantages over conventional quantum execution models. By aligning similarity structure with physical adjacency, the architecture reduces the number of state transfers required during execution, decreases effective circuit depth, and improves overall execution fidelity. Additionally, the execution model scales favorably as system size increases, since interaction distance remains bounded by local neighborhood size rather than global system diameter.

Execution without Global Scheduling Dependencies

Unlike architectures that rely on global execution schedules or time-window partitioning, the similarity-aware execution model described here operates without requiring global task classification or temporal segmentation. Quantum operations are executed based on static or semi-static placement of computational elements, allowing execution locality to emerge naturally from similarity-driven assignment rather than centralized orchestration.

### Execution Phase Operation

During execution, quantum gates are applied to quantum nodes according to the similarity-aware placement established prior to execution. Single-qubit gates may be executed independently at each node, while two-qubit gates may be executed between nodes that are neighbors along a helix or connected via rung couplers. Execution proceeds without requiring redistribution of quantum states across distant regions of the architecture.

For quantum operations that involve computational elements assigned to non-adjacent nodes, execution paths may be realized using a bounded number of intermediate hops along the helix or through rung-based connectivity. In some embodiments, such paths may be selected to minimize angular separation or hop count, thereby preserving locality benefits. Independence from Training or Parameter Optimization

The similarity-aware execution mechanisms disclosed herein operate independently of training procedures, parameter adjustment, or gradient-based optimization. The execution model applies equally to inference-only workloads, constraint-satisfaction problems, graph-based computations, or other quantum algorithms where interaction locality may be inferred prior to execution.

Compatibility with Multiple Quantum Modalities

The similarity-aware execution approach is compatible with multiple quantum hardware modalities, including photonic, superconducting, trapped-ion, and neutral-atom systems. The physical realization of quantum nodes and interconnects may vary by modality, while the logical similarity-based placement and locality-preserving execution principles remain applicable.

The parameters adjustment phase 410 may follow the execution phase 408 and may involve updating variational parameters that control the behavior of quantum gates and operations within the quantum computing architecture. The parameters adjustment phase 410 may enable iterative refinement of quantum circuit performance by modifying rotation angles, coupling strengths, phase offsets, and other adjustable quantities that influence quantum state evolution. The parameters adjustment phase 410 may be performed using gradient-based optimization methods, reinforcement learning techniques, or hybrid quantum-classical approaches that combine quantum measurement outcomes with classical computational resources.

In some embodiments, the gradients computed during the parameters adjustment phase 410 may be aggregated across multiple quantum nodes, segments, or measurement shots to reduce statistical noise and improve the accuracy of parameter updates. The parameters adjustment phase 410 may employ adaptive learning rate schedules, momentum-based optimization, or second-order methods that adjust the magnitude and direction of parameter updates based on the history of previous gradient measurements and the curvature of the cost function landscape.

The error correction phase 412 may follow the parameter adjustment phase. The error correction phase 412 may implement quantum error correction protocols adapted to the double-helix quantum architecture. The error correction phase 412 may detect and correct errors that accumulate during quantum circuit execution in the execution phase 408. The error correction protocols may exploit the geometric properties of the double-helix structure to provide efficient syndrome extraction and error recovery. The error correction phase 412 may operate continuously or periodically during quantum computation to maintain logical qubit fidelity above threshold values required for fault-tolerant operation.

The convergence/evaluation phase 414 may follow the error correction phase 412. The convergence/evaluation phase 414 may determine whether the quantum computing system has reached a satisfactory solution state for the AI task being executed. The convergence/evaluation phase 414 may assess multiple metrics to evaluate whether further iterations of parameter updates and circuit executions are warranted or whether the optimization process may be terminated. In some embodiments, in response to further iterations of parameter updates and/or further circuit executions being warranted, the process flow 400 may return to orchestration phase 406. In response to no further iterations of parameter updates and/or no further circuit executions being warranted, the process flow 400 may proceed the inference and output phase 416.

The inference and output phase 416 may follow the convergence/evaluation phase 414. The inference and output phase 416 may generate final predictions or solutions from the trained quantum computing system. The inference and output phase 416 may process new input data through the optimized quantum circuit to produce actionable outputs for the AI task being executed.

The inference and output phase 416 may include loading new input data into the quantum computing architecture. The new input data may be distinct from the training data used during previous phases. The new input data may represent test samples, validation samples, or production data for which predictions or classifications are desired. The quantum computing architecture may encode the new input data using the same multi-dimensional encoding scheme applied during training. Each data element may be assigned to a quantum node positioned along the two intertwined helices based on the spatial coordinate θ derived from the helical geometry.

The inference and output phase 416 may include executing the quantum circuit with the optimized parameters obtained from the parameter adjustment phase 410. The optimized parameters may include rotation angles for single-qubit gates, coupling strengths for two-qubit gates, phase offsets for positional phase tagging operations, and other parameterized quantum operations. The quantum circuit may apply the same sequence of quantum gates used during training, but with the parameter values fixed at their optimized values rather than being updated iteratively. The quantum gates may transform the quantum states representing the new input data according to the learned mapping encoded in the optimized parameters.

The process flow 400 illustrated in FIG. 4 may represent one example embodiment of how quantum computing operations may be organized and executed on the dual-helix quantum architecture described herein. The particular sequence of phases shown in FIG. 4 may be adapted, modified, or reorganized depending on the specific quantum artificial intelligence workload, hardware configuration, or algorithmic requirements. Alternative embodiments may omit one or more of the phases depicted in FIG. 4, may execute phases in a different order, may perform phases concurrently rather than sequentially, or may include additional phases not explicitly shown in FIG. 4. For example, some quantum neural network training workflows may bypass the inference and output phase 416 during iterative training cycles, while some inference-only workloads may omit the parameter adjustment phase 410 and convergence/evaluation phase 414. The process flow 400 may serve as a representative framework for understanding how the dual-helix quantum architecture may support end-to-end quantum AI computation, but the architecture itself may support a wide variety of computational workflows beyond the specific example illustrated in FIG. 4.

### Illustrative Methods

FIGS. 5-11 illustrate example methods that may be performed using the disclosed architecture. These methods demonstrate how quantum computations may be organized, scheduled, and executed using spatially organized quantum nodes.

The illustrated methods are non-limiting and may be modified, reordered, combined, or omitted depending on the specific application. The disclosed architecture does not require execution of any particular method unless expressly claimed.

FIG. 5 depicts a flowchart of a method 500 for quantum computing, arranged in accordance with at least one embodiment described herein. The method 500 may be programmably performed or controlled by a processor in, e.g., a computer and/or server coupled to the classical computing interface 122. In an example implementation, the method 500 may be performed in whole or in part by the system 100 of FIG. 1A under the control of a classical processor (coupled to the classical computing interface 122). Some embodiments herein may include a non-transitory computer-readable storage medium that includes computer-executable instructions executable by a processor device to perform or control performance of any operations herein, such as the operations of the method 500 of FIG. 5. The method 500 may include one or more of blocks 502, 504, and/or 506.

The method 500 may begin at block 502. At block 502, spatial coordinates may be obtained for each of one or more quantum nodes positioned along two intertwined helices of a quantum computing architecture. The spatial coordinates may be based on angular positions of the quantum nodes along the intertwined helices. Each quantum node may be assigned a deterministic spatial coordinate (xi, yi, zi) derived from an angular position θi according to parametric equations xi=r·cos(θi), yi=r·sin(θi), and zi=(h/2π)·θi, where r denotes the helix radius, h denotes the pitch, and θi=i·Δθ represents the angular coordinate of node i. The angular step Δθ may determine the node density along each helical strand. The spatial coordinate θi may function simultaneously as a logical register within a quantum state representation and as a physical address identifying the geometric location of the node within the three-dimensional helical structure.

The spatial coordinates may be obtained from a configuration file or data structure that stores the geometric parameters of the double-helix architecture. The geometric parameters may include the radius r, the pitch h, and the angular step Δθ. In some embodiments, the spatial coordinates may be calculated at initialization time and stored in a lookup table for efficient access during quantum circuit execution. Alternatively, the spatial coordinates may be computed on-demand based on the node index i and the geometric parameters.

At block 504, a quantum state may be prepared on at least one of the quantum nodes. The quantum state may include a positional mode with a value that corresponds to the spatial coordinate of the at least one of the quantum nodes For example, a positional mode may correspond to angular coordinate θ and may be embedded into the quantum state via a phase tagging operation. A positional-phase tagging operator Upos (k) may be applied to each quantum state, where the operator takes the form Upos(k)=exp(ikθi) for a given spatial frequency parameter k.

At block 506, one or more quantum computations may be performed on the quantum state stored on the at least one of the quantum nodes. The quantum computations may include applying quantum gates, performing measurements, and processing the measurement outcomes to generate computational results. The quantum gates may include single-qubit gates and two-qubit gates that transform the quantum states according to unitary operations.

In some embodiments, neighboring quantum nodes may be selected based on the positional mode of the at least one of the quantum nodes and the neighboring quantum nodes. The selection may restrict gate connections for the at least one of the quantum nodes to the neighboring quantum nodes. The neighboring quantum nodes may be defined as nodes positioned at adjacent angular coordinates along the same helical strand or nodes positioned on different helical strands but at substantially the same angular position. In some embodiments, operations of the gate connections may be organized in a sublayer of the quantum computations so that no quantum node is involved in more than one gate operation per sublayer of the quantum computing architecture.

In some embodiments, operations for a plurality of sublayers in the quantum computing architecture may be performed in parallel. The parallel execution may occur when the sublayers correspond to different segments of the helical structure that do not share any common quantum nodes. Each segment may comprise a contiguous group of quantum nodes along one of the helical strands.

In some embodiments, execution includes configuring one or more control parameter values associated with quantum gate operations. Control parameter values may include rotation angles, coupling strengths, and phase offsets. Control parameter values may be assigned per node or shared across nodes within a segment to reduce configuration overhead.

In some embodiments, a common control parameter value for a segment is determined based on calibration values, measurement results, or other execution metrics obtained from nodes in the segment. The common control parameter value may be broadcast to nodes within the segment prior to executing a subsequent scheduling interval.

In some embodiments, the quantum nodes in the segment may each include a plurality of trainable parameter types that are updated. During the quantum computations, the value for each trainable parameter type may be updated to the same value across all the quantum nodes in the segment such that for each trainable parameter type all quantum nodes in the segment are updated to the same value. For example, a first parameter type may control rotation angles for Ry gates, a second parameter type may control rotation angles for Rz gates, and a third parameter type may control coupling strengths for entangling gates. The segment-scoped parameter tying mechanism may be applied independently to each parameter type. For each parameter type, the local gradients for that parameter type may be aggregated across all nodes in the segment to produce a segment-averaged gradient for that parameter type. The segment-averaged gradient may then be used to update the shared parameter value for that parameter type within the segment.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

FIG. 6 depicts a flowchart of a method 600 for quantum computing, arranged in accordance with at least one embodiment described herein. The method 600 may be programmably performed or controlled by a processor in, e.g., a computer and/or server coupled to the classical computing interface 122. In an example implementation, the method 600 may be performed in whole or in part by the system 100 of FIG. 1A under the control of a classical processor (coupled to the classical computing interface 122). Some embodiments herein may include a non-transitory computer-readable storage medium that includes computer-executable instructions executable by a processor device to perform or control performance of any operations herein, such as the operations of the method 600 of FIG. 6.

At block 602, a quantum neural network with a plurality of network layers may be obtained. The quantum neural network may represent a computational model comprising multiple sequential or interconnected layers that perform quantum operations on input data.

At block 604, each network layer of the plurality of network layers may be assigned to a distinct set of quantum nodes positioned along two intertwined helices of a quantum computing architecture. The assignment may be performed such that adjacent network layers of the plurality of network layers are assigned to sets of quantum nodes on different ones of the intertwined helices. Adjacent network layers may be layers that are consecutive in an ordered sequence of layers in the quantum neural network. The ordered sequence may represent the forward propagation path through the network during inference or the combined forward and backward propagation paths during training.

The assignment process may begin by determining a number of quantum nodes required for a first network layer. The determination may be based on the width of the layer, which may correspond to the number of neurons or quantum processing elements required to represent the layer's computational capacity. A first set of quantum nodes on a first helix of the intertwined helices may be selected, where the number of quantum nodes in the first set equals the determined number of quantum nodes for the first network layer. The first set of quantum nodes may comprise contiguous quantum nodes on the first helix. Contiguous quantum nodes may be positioned at consecutive angular positions along the helical structure without gaps in the angular coordinate sequence.

For a second network layer adjacent to the first network layer, a number of quantum nodes required for the second network layer may be determined. A second set of quantum nodes on a second helix of the intertwined helices may be selected, where the number of quantum nodes in the second set equals the determined number of quantum nodes for the second network layer. The alternating assignment of consecutive layers between the first helix and the second helix may enable efficient inter-layer communication through cross-strand rung connections while maintaining spatial locality within each layer.

The alternating assignment may be implemented according to a mapping strategy wherein odd-numbered layers are assigned to nodes on the first helix chain while even-numbered layers are assigned to nodes on the second helix chain. Layer 1 may be mapped to a contiguous segment of nodes on helix chain A. Layer 2 may be mapped to a corresponding segment on helix chain B. Layer 3 may return to helix chain A. Layer 4 may return to helix chain B. The alternating pattern may continue for all layers in the network. This mapping is illustrative and may be used to support spatial pipelining in which different stages execute in overlapping time windows subject to scheduling constraints that avoid node contention.

Quantum connections may be formed between different sets of quantum nodes on different ones of the intertwined helices. These quantum connections may be implemented through rung couplers that provide direct quantum communication channels between nodes on the first helix and nodes on the second helix. In some embodiments, rung couplers may operate bidirectionally, enabling both forward data flow and backward gradient flow within the same physical interconnect structure. Trainable parameters associated with a network layer of the plurality of network layers may be mapped to quantum connections between quantum nodes of the set of quantum nodes to which the network layer is assigned.

At block 606, one or more quantum computations may be performed using the quantum computing architecture. The quantum computations may include applying quantum gates to quantum nodes, performing measurements, and collecting results according to the schedules and mappings established during the assignment process. The quantum computations may leverage the spatial topology of the double-helix structure to enable parallel execution of quantum operations across multiple segments while maintaining coherence and minimizing errors.

In some embodiments, quantum computations include applying local operations at one or more quantum nodes and applying inter-node operations between neighboring nodes. Local operations may include single-qubit gates and parameterized rotations. Inter-node operations may include entangling gates executed between helical neighbors or between cross-strand node pairs coupled by rung couplers. In some embodiments, measurement outcomes are collected and processed by classical control circuitry to support execution coordination, scheduling updates, and/or error management.

The quantum computations may include two or more sets of quantum nodes on a helix of the intertwined helices forming a spatial data pipeline. For example, while a first set of nodes executes a first circuit stage, a second set of nodes may execute a second circuit stage, such that different regions of the dual-helix structure execute different stages concurrently in space. Spatial pipelining may be coordinated using scheduling intervals and segment boundaries to prevent resource conflicts.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

FIG. 7 depicts a flowchart of a method 700 for quantum computing, arranged in accordance with at least one embodiment described herein. The method 700 may be programmably performed or controlled by a processor in, for example, a computer or server coupled to the classical computing interface 122 of FIG. 1A. In an example implementation, the method 700 may be performed in whole or in part by the system 100 of FIG. 1A under the control of a classical processor coupled to the classical computing interface 122. Some embodiments herein may include a non-transitory computer-readable storage medium that includes computer-executable instructions executable by a processor device to perform or control performance of any operations herein, such as the operations of the method 700 of FIG. 7.

The method 700 may begin at block 702. At block 702, similarities may be determined between a plurality of computational elements for quantum computing. The computational elements may include data from a dataset or variables from a computational model. For data-based computational elements, each element may correspond to a feature vector, a data point, or a tensor component from an input dataset. For model-based computational elements, each element may correspond to a weight parameter, a bias term, or a trainable coefficient within a quantum neural network or variational quantum circuit. In some embodiments, relationships are quantified using a distance metric, correlation metric, dependency metric, or connectivity score representing expected interaction between computational elements during circuit execution. For example, the similarity between computational elements may be quantified using a similarity function that measures the degree of relatedness or correlation between pairs of elements. For data vectors, the similarity function may compute a distance metric such as Euclidean distance, cosine similarity, or kernel-based similarity measures. For model variables, the similarity may be determined by computing connectivity scores that reflect the frequency or strength of interactions between variables during computational operations. The connectivity score for a variable may be calculated by summing the absolute values of coupling coefficients between that variable and all other variables in the model.

In some embodiments, the determination of similarities may involve constructing a similarity graph where nodes represent computational elements and edges represent similarity relationships exceeding a threshold value. Alternatively or additionally, the determination may involve computing a pairwise similarity matrix where each entry represents the similarity between a pair of computational elements.

At block 704, the computational elements may be assigned to quantum nodes positioned along two intertwined helices of a quantum computing architecture based on the similarities between the plurality of computational elements. The assignment may be performed such that similar computational elements are assigned to quantum nodes that are closer in physical proximity to one another than quantum nodes assigned to dissimilar computational elements. The assignment process may utilize the deterministic spatial coordinates of quantum nodes along the helical structure to assign computational elements to specific quantum nodes based on the spatial coordinate of that node along the helical structure. Alternately or additionally, in some embodiments, elements expected to interact frequently are assigned to quantum nodes having smaller angular separation or to nodes coupled by rung connections to reduce routing overhead during execution.

In some embodiments, computational elements are ordered prior to assignment so that related elements are assigned to nearby angular positions along a helix. The ordered elements may be mapped sequentially to quantum nodes such that locality of the ordering corresponds to geometric locality of the node topology. For example, the ordering process may arrange elements such that elements with higher mutual similarity are positioned earlier in the sorted sequence.

In some embodiments, similar computational elements may be assigned to quantum nodes on the same helix of the two intertwined helices. The assignment to a single helix may reduce the physical distance between quantum nodes storing similar computational elements, thereby minimizing the number of cross-helix operations required during quantum computations. For example, the quantum nodes on the first helix chain 102A may store a first subset of computational elements that exhibit high mutual similarity, while the quantum nodes on the second helix chain 102B may store a second subset of computational elements that exhibit high mutual similarity within the second subset but lower similarity to elements in the first subset. In other embodiments, assignment alternates between helices to enable cross-strand entangling operations via rung couplers, depending on circuit structure and scheduling constraints.

At block 706, one or more quantum computations may be performed using the quantum computing architecture. The quantum computations may include applying quantum gates to quantum nodes, performing measurements, and collecting results according to the schedules and mappings established during the assignment process.

In some embodiments, measurement results collected during execution are used by a control system to update scheduling decisions, segment allocations, and/or configuration values for subsequent execution intervals. Such updates may be based on measured error rates, fidelity estimates, routing contention indicators, or other execution metrics.

In some embodiments, segment-level aggregation of measurement results is performed to produce segment-level metrics used to coordinate execution. Segment-level metrics may be combined across segments to produce global execution metrics that inform schedule revision, segment reconfiguration, or error mitigation actions.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

FIG. 8 depicts a flowchart of a method 800 for quantum computing using a dual-helix quantum architecture, arranged in accordance with at least one embodiment described herein. The method 800 may be programmably performed or controlled by a processor in, for example, a computer or server coupled to the classical computing interface 122 of FIG. 1A. In an example implementation, the method 800 may be performed in whole or in part by the system 100 of FIG. 1A under the control of a classical processor coupled to the classical computing interface 122. Some embodiments herein may include a non-transitory computer-readable storage medium that includes computer-executable instructions executable by a processor device to perform or control performance of any operations herein, such as the operations of the method 800 of FIG. 8.

The method 800 may begin at block 802. At block 802, one or more layers of a quantum circuit may be executed on a quantum computing architecture that includes quantum nodes positioned along two intertwined helices. One of the layers may include execution of quantum gates that extend between quantum nodes on different ones of the intertwined helices via rung couplers. In some embodiments, the quantum computing architecture may comprise the dual-helix structure 102 of FIG. 1A.

The execution of one or more layers of the quantum circuit may involve applying quantum gates to quantum states stored at the quantum nodes. In some embodiments, only a single quantum operation is performed at each quantum node during execution of any one layer, preventing a node from participating in multiple gate operations simultaneously. In some embodiments, gate operations are organized into sublayers using an edge-coloring algorithm applied to a connectivity graph so that no two gates in a sublayer share a quantum node, enabling parallel execution of all gates in the sublayer.

In some embodiments, a second layer of the one or more layers may include execution of quantum gates that extend between physically adjacent quantum nodes along the same helix. Physically adjacent quantum nodes may be quantum nodes positioned at consecutive angular positions along the helical structure without gaps in the angular coordinate sequence. The second layer may be executed before the one of the layers that includes quantum gates extending between quantum nodes on different helices. In some embodiments, a third layer of the one or more layers may include execution of single qubit gates. The third layer may be executed before the second layer.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

FIG. 9 depicts a flowchart of a method 900 for quantum computing using a dual-helix quantum architecture, arranged in accordance with at least one embodiment described herein. The method 900 may be programmably performed or controlled by a processor in, for example, a computer or server coupled to the classical computing interface 122 of FIG. 1A. In an example implementation, the method 900 may be performed in whole or in part by the system 100 of FIG. 1A under the control of a classical processor coupled to the classical computing interface 122. Some embodiments herein may include a non-transitory computer-readable storage medium that includes computer-executable instructions executable by a processor device to perform or control performance of any operations herein, such as the operations of the method 900 of FIG. 9.

The method 900 may begin at block 902. At block 902, data regarding quantum gates and quantum nodes associated with each quantum gate may be obtained. The quantum gates may form part of a quantum circuit on a quantum computing architecture that includes quantum nodes positioned along two intertwined helices. The quantum computing architecture may comprise the dual-helix structure 102 of FIG. 1A. The quantum nodes may be positioned along the first helix chain 102A and the second helix chain 102B.

The data regarding quantum gates may include gate type, target node identifiers, control node identifiers, and any parameters associated with each gate. The data regarding quantum nodes may include spatial coordinates, angular positions along a helix, and helix membership. The data may be obtained from a circuit specification and/or produced by a compiler configured to map a logical circuit to the physical topology.

At block 904, an execution order of the quantum gates may be scheduled based on the data. The scheduling may organize the quantum gates into one or more layers of quantum gate execution. One of the one or more layers may be scheduled to include quantum gates that extend between quantum nodes on different ones of the intertwined helices. The scheduling process may determine the temporal sequence in which quantum gates are executed and may group gates into layers such that gates within a layer may be executed in parallel without conflicts.

The scheduling process may classify quantum gates based on the physical distance between the quantum nodes involved in each gate operation. For example, single-qubit gates may be assigned to an early layer, two-qubit gates between helical neighbor nodes may be assigned to a second layer, cross-strand rung gates may be assigned to a third layer, and long-range gates requiring multi-hop routing or teleportation may be assigned to a later layer.

In some embodiments, scheduling incorporates positional information associated with quantum nodes. For example, a positional mode may represent angular coordinate θi of a node, and gates connecting nodes with similar θ values may be preferentially scheduled earlier or grouped to reduce routing distance and contention.

Gates connecting nodes with dissimilar positional modes may be assigned to later layers, and scheduling may further incorporate segment boundaries such that intra-segment gates are scheduled earlier and inter-segment gates are scheduled later, enabling concurrent execution across segments while controlling inter-segment contention.

The scheduling process may incorporate information about segment boundaries when determining gate assignments to layers. The dual-helix structure may be divided into segments, where each segment comprises a contiguous group of quantum nodes along a helical strand and segment boundaries are defined by angular positions along the helix. In some embodiments, gates that connect nodes within a same segment are assigned to earlier layers, and gates that connect nodes in different segments are assigned to later layers, thereby enabling parallel intra-segment execution while controlling inter-segment contention.

At block 906, the quantum circuit may be executed based on the scheduled execution order of the quantum gates. The execution may involve applying quantum gates to quantum states stored at the quantum nodes according to the scheduled sequence of layers and sublayers. The quantum gates may transform the quantum states according to unitary operations parameterized by the gate parameters specified in the quantum circuit specification.

The execution of the first layer may involve applying single-qubit gates to individual quantum nodes. The single-qubit gates may be applied in parallel across all quantum nodes that require such operations. The execution of the second layer may involve applying two-qubit gates between helical neighbor nodes. The execution of the third layer may involve applying cross-strand rung gates between quantum nodes on different helical strands. The execution of the fourth layer may involve implementing long-range gates through quantum teleportation or multi-hop routing.

The execution of quantum gates may be coordinated by multiple components of the quantum computing system 100. The central control module 108 may coordinate the timing of gate operations across multiple quantum nodes. The task scheduler 110 may determine which quantum nodes execute which gates during each layer. The sensors 114 may monitor the fidelity of gate operations. The error correction module 106 may detect and correct errors that occur during gate execution.

The scheduling process may incorporate dynamic adjustments based on real-time feedback from the quantum hardware. If a particular quantum node or connection exhibits degraded performance, the scheduling process may reassign gates involving that node or connection to alternative nodes or connections. The dynamic adjustment may involve re-running the edge-coloring algorithm with updated connectivity information that excludes or deprioritizes the degraded elements.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

FIG. 10 illustrates a method 1000 for executing an artificial intelligence task on a quantum computing architecture, arranged in accordance with at least one embodiment described herein. The method 1000 may be programmably performed or controlled by a processor in, e.g., a computer and/or server coupled to the classical computing interface 122. In an example implementation, the method 1000 may be performed in whole or in part by the system 100 of FIG. 1A under the control of a classical processor (coupled to the classical computing interface 122). Some embodiments herein may include a non-transitory computer-readable storage medium that includes computer-executable instructions executable by a processor device to perform or control performance of any operations herein, such as the operations of the method 1000 of FIG. 10. The method 1000 may include one or more of blocks 1002, 1004, 1006, 1008, and/or 1010.

The method 1000 may begin at block 1002. At block 1002, a plurality of computational elements associated with the artificial intelligence task may be obtained. The computational elements may represent data samples, features, variables, or other discrete entities that participate in the artificial intelligence computation. In some embodiments, the computational elements may correspond to image patches derived from an input tensor. In other embodiments, the computational elements may correspond to variables of a graph-based optimization problem or an Ising-type model. In further embodiments, the computational elements may correspond to token embeddings of a transformer model. The computational elements may be obtained from a data source such as a file, database, network stream, or memory buffer.

At block 1004, similarity relationships among the computational elements may be determined. The similarity relationships may be based on at least one of statistical similarity, interaction frequency, connectivity strength, spatial adjacency within a data representation, or graph-based correlation metrics. The determination of similarity relationships may enable the assignment of computational elements to quantum nodes in a manner that preserves semantic or logical proximity in the physical topology of the quantum computing architecture.

In some embodiments, determining similarity relationships may include computing a similarity metric selected from cosine similarity, Euclidean distance, kernel similarity, mutual information, or graph-based connectivity weight. For data vectors, the similarity metric may quantify the degree of resemblance between pairs of computational elements.

For model variables in an optimization problem, the similarity may be determined by computing connectivity scores that reflect the frequency or strength of interactions between variables. In some embodiments, determining similarity relationships may include constructing a similarity graph in which nodes represent computational elements and weighted edges represent similarity strength. The similarity graph may be analyzed using spectral decomposition, graph traversal, or clustering to produce a similarity-preserving ordering.

At block 1006, a quantum computing architecture may be provided. The quantum computing architecture may include a plurality of quantum nodes arranged along two intertwined helices. Each quantum node may be associated with an angular position along a helical path. Each quantum node may be positioned at a deterministic spatial coordinate (xᵢ, yᵢ, zᵢ) derived from an angular position θᵢ. The angular step Δθ may determine the node density along each helical strand.

The quantum computing architecture may include rung couplers that provide quantum communication channels between quantum nodes on different helices. The quantum computing architecture may include aggregator nodes positioned at turn boundaries of the helices. Each aggregator node may be configured to collect and process quantum information from quantum nodes within a helical turn.

At block 1008, the computational elements may be assigned to the quantum nodes based on the similarity relationships. The assignment may be performed such that computational elements having higher similarity are assigned to quantum nodes having smaller angular separation along at least one of the intertwined helices. This assignment strategy may minimize communication overhead during quantum operations by ensuring that computational elements that interact frequently or strongly are positioned on physically adjacent or nearby quantum nodes.

In some embodiments, assigning the computational elements may include mapping the computational elements in similarity-preserving order to quantum nodes in ascending angular order along a helix. The computational elements may be sorted according to a similarity-preserving ordering obtained from the similarity graph analysis. The sorted computational elements may be assigned sequentially to quantum nodes along one of the helices. For example, the first computational element in the sorted sequence may be assigned to the quantum node at angular position θ₀, the second computational element may be assigned to the quantum node at angular position θ₁=Δθ, and so forth.

In some embodiments, computational elements exhibiting similarity above a threshold may be assigned to quantum nodes on a same helical strand. The threshold may be selected based on the distribution of similarity values in the similarity graph. Computational elements with pairwise similarity exceeding the threshold may be grouped together and assigned to contiguous nodes on a single helix.

In other embodiments, computational elements exhibiting lower similarity may be assigned to quantum nodes on different helical strands. Computational elements with pairwise similarity below the threshold may be assigned to nodes on opposite helices.

In some embodiments, computational elements that interact bidirectionally may be assigned to quantum nodes connected by cross-strand couplers. The bidirectional interaction may be determined from the coupling matrix J of an optimization problem or from the architecture of a neural network model. For example, in an Ising model, variables i and j that have a non-zero coupling coefficient Jᵢⱼ may be considered to interact bidirectionally. These variables may be assigned to quantum nodes Aₖ and Bₖ that are connected by a rung coupler, where the cross-strand couplers connect quantum nodes having substantially equal angular positions along the two helices.

The assignment process may utilize a cost function that balances multiple objectives. The cost function may include terms representing the total distance-weighted coupling strength between computational elements, the load balance across quantum nodes, and the connectivity score of each computational element. For each computational element to be assigned, a set of candidate quantum nodes may be evaluated. The cost function may be computed for each candidate node. The candidate node that minimizes the cost function may be selected as the assignment location for the computational element.

At block 1010, quantum gate operations associated with the artificial intelligence task may be executed. The quantum gate operations may be executed between quantum nodes that are adjacent along a helix or connected by cross-strand couplers. The execution of quantum gate operations may implement the computational logic of the artificial intelligence task, such as forward propagation through a neural network, evaluation of a cost function in an optimization problem, or inference operations in a machine learning model.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

FIG. 11 illustrates a method 1100 for executing an artificial intelligence task on a quantum computing architecture, arranged in accordance with at least one embodiment described herein. The method 1100 may be programmably performed or controlled by a processor in, e.g., a computer and/or server coupled to the classical computing interface 122 of FIG. 1A. In an example implementation, the method 1100 may be performed in whole or in part by the system 100 of FIG. 1A under the control of a classical processor coupled to the classical computing interface 122. Some embodiments herein may include a non-transitory computer-readable storage medium that includes computer-executable instructions executable by a processor device to perform or control performance of any operations herein, such as the operations of the method 1100 of FIG. 11. The method 1100 may include one or more of blocks 1102, 1104, and/or 1106.

The method 1100 may begin at block 1102. At block 1102, similarity relationships among computational elements associated with an artificial intelligence task may be analyzed. The computational elements may represent data samples, features, variables, or other discrete entities that participate in the artificial intelligence computation. The similarity relationships may be based on at least one of statistical similarity, interaction frequency, connectivity strength, spatial adjacency within a data representation, or graph-based correlation metrics. The analysis of similarity relationships may enable the assignment of computational elements to quantum nodes in a manner that preserves semantic or logical proximity in the physical topology of the quantum computing architecture.

In some embodiments, analyzing similarity relationships may include computing a similarity metric selected from cosine similarity, Euclidean distance, kernel similarity, mutual information, or graph-based connectivity weight. For data vectors, the similarity metric may quantify the degree of resemblance between pairs of computational elements. For model variables in an optimization problem, the similarity may be determined by computing connectivity scores that reflect the frequency or strength of interactions between variables. In some embodiments, analyzing similarity relationships may include constructing a similarity graph in which nodes represent computational elements and weighted edges represent similarity strength.

At block 1104, the computational elements may be assigned to quantum nodes arranged along two intertwined helices according to angular proximity. The assignment may be performed such that computational elements having higher similarity are assigned to quantum nodes having smaller angular separation along at least one of the intertwined helices

In some embodiments, assigning the computational elements may include mapping the computational elements in similarity-preserving order to quantum nodes in ascending angular order along a helix. The computational elements may be sorted according to a similarity-preserving ordering obtained from the similarity graph analysis. The sorted computational elements may be assigned sequentially to quantum nodes along one of the helices.

In some embodiments, computational elements exhibiting similarity above a threshold may be assigned to quantum nodes on a same helical strand. The threshold may be selected based on the distribution of similarity values in the similarity graph. In other embodiments, computational elements exhibiting lower similarity may be assigned to quantum nodes on different helical strands. Computational elements with pairwise similarity below the threshold may be assigned to nodes on opposite helices. In some embodiments, computational elements that interact bidirectionally may be assigned to quantum nodes connected by cross-strand couplers.

The assignment process may utilize a cost function that balances multiple objectives. The cost function may include terms representing the total distance-weighted coupling strength between computational elements, the load balance across quantum nodes, and the connectivity score of each computational element.

At block 1106, quantum operations may be executed such that interactions between similar computational elements occur between geometrically proximate quantum nodes. The execution of quantum operations may implement the computational logic of the artificial intelligence task, such as forward propagation through a neural network, evaluation of a cost function in an optimization problem, or inference operations in a machine learning model.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

### Hardware and Implementation Variants

The quantum computing architecture described herein may be realized through various physical implementations. Different quantum node architectures may be employed depending on the specific application requirements, operational environment, and available fabrication technologies. The choice of implementation may affect parameters such as coherence time, gate fidelity, operating temperature, and scalability, but the fundamental principles of the double-helix topology remain applicable across platforms. Note that the disclosed techniques related to implementing AI on quantum hardware are not limited to any specific hardware platform.

Furthermore, control systems, such as those described with respect to FIG. 1A that may be used with duel-helix architecture, may include classical processors, field-programmable gate arrays (FPGAs), application-specific integrated circuits (ASICs), or hybrid control systems. Quantum and classical components may communicate using wired or wireless interconnects. Any language directed to a computer includes any suitable combination of computing devices or network platforms, including servers, interfaces, systems, databases, agents, engines, controllers, and modules operating individually or collectively. Computing devices may include a processor configured to execute software instructions stored on a tangible, non-transitory computer-readable medium. Data exchanges among devices may be conducted over one or more networks including the Internet, LAN, WAN, VPN, packet-switched networks, circuit-switched networks, or other suitable networks.

### General Advantages

The spatial organization and execution framework described herein may provide one or more advantages, including improved scalability, reduced routing overhead, increased parallelism, and flexibility in supporting diverse quantum algorithms. Such advantages may vary depending on the implementation and workload.

### Non-Limiting Embodiments and Combinations

Further, note that features described in connection with one or more embodiments may be omitted, substituted, or combined with features of other embodiments unless the context indicates otherwise. The scope of the disclosure is defined solely by the claims.

Throughout the specification and claims, the following terms take the meanings explicitly associated herein, unless the context clearly dictates otherwise. The phrase “in one embodiment” as used herein does not necessarily refer to the same embodiment, though it may. Thus, as described below, various embodiments of the disclosure may be readily combined, without departing from the scope or spirit of the invention. As used herein, the term “or” is an inclusive “or” operator and is equivalent to the term “and/or,” unless the context clearly dictates otherwise. The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors. In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

### Additional Examples

1. A computer-implemented method for executing an artificial intelligence task on a quantum computing architecture, the method comprising:
obtaining a plurality of computational elements associated with the artificial intelligence task;
determining similarity relationships among the computational elements based on at least one of statistical similarity, interaction frequency, connectivity strength, spatial adjacency within a data representation, or graph-based correlation metrics;
providing a quantum computing architecture comprising a plurality of quantum nodes arranged along two intertwined helices, each quantum node being associated with an angular position along a helical path;
assigning the computational elements to the quantum nodes based on the similarity relationships such that computational elements having higher similarity are assigned to quantum nodes having smaller angular separation along at least one of the intertwined helices; and
executing quantum gate operations associated with the artificial intelligence task on the quantum computing architecture between quantum nodes that are adjacent along a helix or connected by cross-strand couplers.

2. The method of embodiment 1, wherein determining similarity relationships comprises computing a similarity metric selected from cosine similarity, Euclidean distance, kernel similarity, mutual information, or graph-based connectivity weight.

3. The method of any of embodiments 1-2, wherein determining similarity relationships comprises constructing a similarity graph in which nodes represent computational elements and weighted edges represent similarity strength.

4. The method of embodiment 3, wherein the similarity graph is analyzed using spectral decomposition, graph traversal, or clustering to produce a similarity-preserving ordering.

5. The method of any of embodiments 1-4, wherein assigning the computational elements comprises mapping the computational elements in similarity-preserving order to quantum nodes in ascending angular order along a helix.

6. The method of any of embodiments 1-5, wherein computational elements exhibiting relatively higher similarity are assigned to quantum nodes on a same helical strand.

7. The method of any of embodiments 1-6, wherein computational elements exhibiting lower similarity are assigned to quantum nodes on different helical strands.

8. The method of any of embodiments 1-7, wherein computational elements that interact bidirectionally are assigned to quantum nodes connected by cross-strand couplers.

9. The method of embodiment 8, wherein the cross-strand couplers connect quantum nodes having substantially equal angular positions along the two helices.

10. The method of any of embodiments 1-9, wherein the computational elements correspond to image patches derived from an input tensor.

11. The method of embodiment 10, wherein spatially adjacent image patches are assigned to quantum nodes having adjacent angular positions along a helix.

12. The method of any of embodiments 1-11, wherein the computational elements correspond to variables of a graph-based optimization problem or an Ising-type model.

13. The method of embodiment 12, wherein variables having stronger coupling coefficients are assigned to quantum nodes having reduced angular separation.

14. The method of any of embodiments 1-13, wherein the computational elements correspond to token embeddings of a transformer model.

15. A quantum computing system configured to execute artificial intelligence tasks, the system comprising:
a plurality of quantum nodes arranged along two intertwined helices, each quantum node having a deterministic angular position along a helical path;
at least one memory storing a plurality of instructions, that when executed by the quantum computing system, cause or direct the performance of operations comprising:
   determine similarity relationships among the computational elements;
   map the computational elements to the quantum nodes such that computational elements exhibiting higher similarity are mapped to quantum nodes having reduced angular separation along at least one helix; and
   apply quantum gate operations between quantum nodes corresponding to interacting computational elements, the quantum gate operations biased toward geometrically proximate quantum nodes to reduce routing overhead.

16. The system of embodiment 15, wherein the operations further comprise update the mapping of computational elements to quantum nodes between execution cycles based on updated similarity information.

17. The system of any of embodiments 15-16, wherein the operations further comprise construct and analyze a similarity graph to generate a similarity-preserving ordering used by the assignment module.

18. A method comprising:
analyze similarity relationships among computational elements associated with an artificial intelligence task;
assign, based on the similarity relationships, the computational elements to quantum nodes, arranged along two intertwined helices, according to angular proximity between the quantum nodes; and
execute quantum operations such that interactions between similar computational elements occur between geometrically proximate quantum nodes.

19. The method of embodiment 18, wherein the assigning the computational elements comprises mapping the computational elements in similarity-preserving order to quantum nodes in ascending angular order along a helix.

20. A quantum computing architecture for executing artificial intelligence workloads, the quantum computing architecture including a dual-helix arrangement and the dual-helix arrangement defines both intra-helix adjacency and cross-strand adjacency used by the execution of the artificial intelligence workloads, comprising:
a dual-helix arrangement of quantum nodes forming two intertwined helical chains;
cross-strand couplers connecting quantum nodes on different helices at corresponding or offset angular positions; and
one or more processors configured to:
   assign computational elements to quantum nodes based on similarity relationships among the computational elements; and
   perform quantum interactions predominantly between quantum nodes that are adjacent along a helix or connected by cross-strand couplers.

21. A non-transitory computer-readable medium storing instructions that, when executed by a control system of a quantum computing system, cause the system to perform the method of any of embodiments 1-14 and 18-19.

1. A computer-implemented method for executing an artificial intelligence task on a quantum computing architecture, the method comprising:
obtaining a plurality of computational elements associated with the artificial intelligence task;
determining similarity relationships among the computational elements based on at least one of statistical similarity, interaction frequency, connectivity strength, spatial adjacency within a data representation, or graph-based correlation metrics;
providing a quantum computing architecture comprising a plurality of quantum nodes arranged along two intertwined helices, each quantum node being associated with an angular position along a helical path;
assigning the computational elements to the quantum nodes based on the similarity relationships such that computational elements having higher similarity are assigned to quantum nodes having smaller angular separation along at least one of the intertwined helices; and
executing quantum gate operations associated with the artificial intelligence task on the quantum computing architecture between quantum nodes that are adjacent along a helix or connected by cross-strand couplers.

2. The method of claim 1, wherein determining similarity relationships comprises computing a similarity metric selected from cosine similarity, Euclidean distance, kernel similarity, mutual information, or graph-based connectivity weight.

3. The method of claim 1, wherein determining similarity relationships comprises constructing a similarity graph in which nodes represent computational elements and weighted edges represent similarity strength.

4. The method of claim 3, wherein the similarity graph is analyzed using spectral decomposition, graph traversal, or clustering to produce a similarity-preserving ordering.

5. The method of claim 1, wherein assigning the computational elements comprises mapping the computational elements in similarity-preserving order to quantum nodes in ascending angular order along a helix.

6. The method of claim 1, wherein computational elements exhibiting relatively higher similarity are assigned to quantum nodes on a same helical strand.

7. The method of claim 1, wherein computational elements exhibiting lower similarity are assigned to quantum nodes on different helical strands.

8. The method of claim 1, wherein computational elements that interact bidirectionally are assigned to quantum nodes connected by cross-strand couplers.

9. The method of claim 8, wherein the cross-strand couplers connect quantum nodes having substantially equal angular positions along the two helices.

10. The method of claim 1, wherein the computational elements correspond to image patches derived from an input tensor.

11. The method of claim 10, wherein spatially adjacent image patches are assigned to quantum nodes having adjacent angular positions along a helix.

12. The method of claim 1, wherein the computational elements correspond to variables of a graph-based optimization problem or an Ising-type model.

13. The method of claim 12, wherein variables having stronger coupling coefficients are assigned to quantum nodes having reduced angular separation.

14. The method of claim 1, wherein the computational elements correspond to token embeddings of a transformer model.

15. A quantum computing system configured to execute artificial intelligence tasks, the system comprising:
a plurality of quantum nodes arranged along two intertwined helices, each quantum node having a deterministic angular position along a helical path;
at least one memory storing a plurality of instructions, that when executed by the quantum computing system, cause or direct the performance of operations comprising:
determine similarity relationships among the computational elements;
map the computational elements to the quantum nodes such that computational elements exhibiting higher similarity are mapped to quantum nodes having reduced angular separation along at least one helix; and
apply quantum gate operations between quantum nodes corresponding to interacting computational elements, the quantum gate operations biased toward geometrically proximate quantum nodes to reduce routing overhead.

16. The system of claim 15, wherein the operations further comprise update the mapping of computational elements to quantum nodes between execution cycles based on updated similarity information.

17. The system of claim 15, wherein the operations further comprise construct and analyze a similarity graph to generate a similarity-preserving ordering used by the assignment module.

18. A method comprising:
analyze similarity relationships among computational elements associated with an artificial intelligence task;
assign, based on the similarity relationships, the computational elements to quantum nodes, arranged along two intertwined helices, according to angular proximity between the quantum nodes; and
execute quantum operations such that interactions between similar computational elements occur between geometrically proximate quantum nodes.

19. The method of claim 18, wherein the assigning the computational elements comprises mapping the computational elements in similarity-preserving order to quantum nodes in ascending angular order along a helix.

20. A quantum computing architecture for executing artificial intelligence workloads, the quantum computing architecture including a dual-helix arrangement and the dual-helix arrangement defines both intra-helix adjacency and cross-strand adjacency used by the execution of the artificial intelligence workloads, comprising:
a dual-helix arrangement of quantum nodes forming two intertwined helical chains;
cross-strand couplers connecting quantum nodes on different helices at corresponding or offset angular positions; and
one or more processors configured to:
assign computational elements to quantum nodes based on similarity relationships among the computational elements; and
perform quantum interactions predominantly between quantum nodes that are adjacent along a helix or connected by cross-strand couplers.
